(19) United States
(12) Patent Application Publication
(10) Pub. No.: US 2015/0360983 A1
(43) Pub. Date: Dec. 17, 2015

(54) WATER REUSE SYSTEM AND METHOD

(71) Applicant: COLORADO SCHOOL OF MINES, Golden, CO (US)

(72) Inventors: Pravin S. MURKUTE, Columbia, MD (US); Tzahi Y. CATH, Golden, CO (US); Ryan W. HOLLOWAY, Golden, CO (US); John R. HERRON, Corvallis, OR (US); Keith A. LAMPI, Corvallis, OR (US); Andrew WAIT, Lakewood, CO (US); Walter L. SCHULTZ, Scottsdale, AZ (US)

(21) Appl. No.: 14/760,181

(22) PCT Filed: Jan. 10, 2014
(86) PCT No.: PCT/US14/11126

§ 371 Date: Jul. 9, 2015

Related U.S. Application Data
(60) Provisional application No. 61/751,195, filed on Jan. 10, 2013.
(60) Provisional application No. 61/876,108, filed on Sep. 10, 2013.

(51) Int. Cl. C02F 3/30; C02F 3/12; C02F 3/28; C02F 1/42; B01D 65/02; C02F 11/02; C02F 11/04; B01D 61/00; B01D 61/08; B01D 61/18; C02F 1/44; C02F 1/52

(52) U.S. Cl. CPC C02F 3/303; C02F 1/445; C02F 1/444; C02F 3/1268; C02F 3/308; C02F 3/2853; C02F 1/42; C02F 1/441; C02F 1/442; C02F 3/1263; C02F 1/5281; C02F 11/02; C02F 11/04; B01D 61/005; B01D 61/08; B01D 61/18; B01D 65/02; C02F 2101/105

(57) ABSTRACT

Disclosed herein are processes, methods, and devices for use in water reclamation, including a system comprising an osmotic membrane bioreactor (OMBR), a microporous membrane bioreactor (MBR), a biological nitrogen removal system (BNR), and a source of high osmotic pressure solution (draw solution), and a reconcentration process to achieve high water recovery at low energy expenditure, which may produce purified water streams of different qualities in parallel. Disclosed processes, methods, and systems for the treating of waste water may further provide for production other useful products, for example, fertilizers. One embodiment of the disclosed systems, processes, or methods may include a hybrid membrane bioreactor comprising a semipermeable membrane and a porous membrane.

This application claims benefit under 35 U.S.C. §119(e) to U.S. Provisional Patent Application Nos. 61/751,195, filed Jan. 10, 2013, and 61/876,108, filed Sep. 10, 2013, both of which are incorporated herein by reference in their entireties.

### BACKGROUND

As the demand for water grows, industry and communities seek processes for the reclamation and purification of impaired water for indirect and direct potable reuse. Such streams include impaired surface water, domestic and industrial wastewaters, runoff water, and more. Some processes that have been used to reclaim wastewater include biological activated sludge processes, biological nutrient removal processes, chemical processes such as softening, disinfection, and oxidation, and membrane processes, including microfiltration and ultrafiltration for direct treatment of sludge and nanofiltration and reverse osmosis for purification of wastewater effluents.

In recent years, membrane bioreactor (MBR) processes have been implemented in many small and large wastewater treatment facilities. These processes provide many benefits over conventional activated sludge processes, including smaller footprint, elimination of gravity sedimentation basins, consistent and higher quality effluent suitable for reverse osmosis or nanofiltration feed, and enhanced biological processes that may facilitate enhanced nutrient removal.

Membrane fouling and scaling in pressure-driven membrane processes (e.g., in reverse osmosis, nanofiltration, ultrafiltration, and microfiltration) are often a major concern, as they may increase the operating and maintenance costs of the systems. Pretreatment of the feed water is a way of reducing fouling and scaling, but is typically expensive. Additional drawbacks of most membrane-based systems is increased salt content of the feed stream, which typically reduces the flux of product water due to the higher osmotic pressure difference across the membrane.

Water reclamation has become a common practice to supply the growing demand for water in areas that do not have access to the ocean. Short supply of potable water in inland areas pose much more complicated challenges to water authorities, governments, and stakeholders. Inland regions are restricted to the use of surface water and groundwater, and water reuse may be a major shift in the distribution of resources in their water portfolio.

Municipal and industrial wastewaters also pose several problems for the environment. For example, wastewater may contain high concentrations of nitrogen (N) and phosphorus (P) compounds, and in some cases, wastewater may be discharged with little or no treatment into natural bodies of water, for example estuaries, bays, rivers, or lakes. In these cases, nitrogen and/or phosphorus containing compounds can accumulate and give rise to eutrophication, the process by which a body of water becomes enriched in dissolved nutrients (such as phosphates) that stimulate the growth of aquatic plant life. In some cases, the process of eutrophication may result in the depletion of dissolved oxygen due to overgrowth of aquatic plant life, which leads to the decline of other organisms dependent on dissolved oxygen. Thus, processes are desired that are capable of lowering the concentration of nitrogen and phosphorous containing compounds in wastewater prior to discharge. However, existing methods for nitrogen and phosphorus removal may add significant capital/operating costs and complexity to the wastewater treatment process and make it vulnerable to biological process upsets.

The processes, methods, and systems described herein are directed to meeting these needs. The described processes, methods, and systems may use wastewater and seawater sources to produce potable and non-potable water at a lower cost. In addition, the described processes, methods, and systems may be used to produce beneficial chemicals and compounds as well as allow discharge of water that is less harmful to the environment.

### FIELD

This invention pertains generally to liquid-treatment methods. Particular embodiments provide methods usable for producing beneficial products including purified streams or otherwise useful potable and reclaimed water streams from a source of non-potable or otherwise impaired water.

### SUMMARY

A water reclamation process is presented. The process includes steps or acts that may at least or in part, as a system for performing the method, utilize an osmotic membrane bioreactor (OMBR), a microporous membrane bioreactor (MBR), a biological nitrogen removal system (BNR), and a source of high osmotic pressure solution (draw solution), and a reconcentration process to achieve high water recovery at low energy expenditure. Benefits of the method and/or system may include parallel production of purified water streams of different qualities, including potable and non-potable water, recovery of nutrients, and low-energy desalination of high salinity water, including seawater. The method and/or system utilize semi-permeable and porous membranes (submerged and/or external) in conjunction with a bioreactor and auxiliary subsystems and/or methods to treat wastewater. Through osmosis in one example of this implementation, water diffuses from a mixed liquor (activated sludge) across the semi-permeable membrane, and into a draw solution having a higher osmotic pressure (e.g., seawater or any concentrated natural or synthetic brine). Through microfiltration or ultrafiltration, in one embodiment of this implementation, water and dissolved solids and salts are drawn from the mixed liquor (activated sludge), producing water of high quality for non-potable reuse applications and simultaneously control the chemistry in the bioreactors. In certain applications the OMBR process as described herein may be used in conjunction with a seawater desalination process (e.g., reverse osmosis, RO) in order to reduce the energy requirement of the desalination process. In further applications, high value dissolved constituents may be harvested from the bioreactor using the combined effects of the parallel OMBR and MBR membranes.

Embodiments of the present disclosure provide methods for purifying a liquid, such methods acting, for example, to reduce its solute load. In particular implementations, the liquid to be purified is seawater, brackish-water, impaired-water, wastewater, or other source (generally referred to as source water). In further implementations, the source water is purified to a potable level.

In one aspect, systems are provided for purifying a liquid, such as source water. In one example, the system includes a water purification unit, such as a desalination unit, in combination with a forward-osmosis unit that dilutes a draw solution stream entering the desalination unit. The forward-osmosis unit is located hydraulically upstream of the desalination unit and is configured to receive a stream of draw solution. In some embodiments, the draw solution may be from the desalination unit. The draw solution passes through the forward-osmosis unit on a receiving side of a semipermeable membrane in the forward-osmosis unit. Meanwhile, a source water stream having a relatively low osmotic potential (e.g., a liquid having a low salinity compared to the high salinity draw solution) passes through the forward-osmosis unit on the feed side of the forward-osmosis membrane, which results in a net transfer of water through the membrane from low osmolality source water to the draw solution, diluting the draw solution. In a particular implementation, the resulting diluted source water is used as a feed for the desalination unit. By diluting the feed stream entering the desalination unit, the energy expenditure (per unit of product water) of the desalination unit may be reduced. The desalination unit produces a stream of product water and a stream of brine concentrate.

A further example of the system may include the components of the previous example and further include a treatment unit located upstream or downstream of the forward-osmosis unit. The treatment unit treats the source water before the source water passes through the forward-osmosis unit. In particular implementations, the treatment unit reduces the particulate or solute load (or both) of the source water. In certain examples, the treatment unit is configured to perform one or more of coagulation, biological nitrification, biological nitrification-denitrification, anaerobic digestion, filtration, ion-exchange, chemical addition, and other membrane process, in any suitable order.

In a particular implementation, the treatment unit is a fully mixed reactor or a bioreactor. In further implementations, the treatment unit is a baffled reactor. In yet additional implementations, liquid, solid, or gaseous chemicals might be added to the treatment process.

In another example, the system includes the components in the first described embodiment as well as a microfiltration or ultrafiltration membrane system situated hydraulically parallel to the forward-osmosis unit, in the same holding tank/reactor. The forward-osmosis system receives a stream of draw solution, or concentrate, (such as concentrated brine from the desalination unit) from the water purification unit, dilutes the concentrate, and optionally returns the diluted concentrate to the water purification unit. Simultaneously, the microporous membrane system draws water and many dissolved constituents from the common holding tank of the two membranes, producing purified water suitable for most non-potable applications. Thus, suspended solids remain in the bioreactor and may be concentrated therein.

As a result, the chemistry and biological conditions in the source water of the mutual holding tank/reactor may be controlled. Furthermore, purified water of different quality (both potable and non-potable) may be produced simultaneously by one hybrid system.

The parallel microporous membrane system may be operated to extract useful constituents from the source water in the mutual holding reactor. In a particular implementation, a resource recovery system may be used to extract dissolved constituents from the permeate water of the microporous microfiltration or ultrafiltration membrane. In a further implementation a desalination process such as reverse osmosis, nanofiltration, electrodialysis, or other separation processes may be used to recover clean water from the microporous membrane permeate stream and concentrate one or more dissolved constituents. In specific implementations, liquid, solid, or gaseous chemicals might be added to the resource recovery system to facilitate resource recovery.

In further implementations, a side stream of the mutual holding tank/reactor may be directed to an energy and/or resource recovery unit for further recovery of resources such as nutrients or minerals and simultaneous generation of energy from biogases, biosolids, or bioliquids.

According to a further example, the method and system may be similar to the previous example but may further include a source of draw solution for the forward-osmosis unit having high osmotic pressure. The source of draw solution may be, for example, seawater, hypersaline reservoir/lake, industrial brine, or any other source of high osmotic pressure liquid. In a particular implementation, the high osmotic pressure stream may be diluted before further processing of the stream. In a further implementation, the diluted stream may be used for other beneficial purposes such as road salting, hydraulic fracturing, or any other use of diluted brine.

The above-described systems and/or related methods may be used for processes other than the desalination of seawater and treatment of wastewater. Other processes may include desalination of brackish water, concentration of foods or beverages, and concentration or purification of chemical or pharmaceutical products.

The disclosed processes, methods, and systems involve removal and/or recovery of biological nutrients while improving the quantity, yield, purity, and efficiency of nutrient recovery

The disclosed invention comprises a hybrid membrane bioreactor comprising osmotic (semipermeable) and porous (microfiltration or ultrafiltration) membranes that can be operated in a mode that allows more efficient removal of nitrogen and phosphorus compounds from wastewater. In some embodiments, the disclosed method combines fertilizer recovery methods while operating the bioreactor either with or without biological nutrient removal (anoxic and/or anaerobic treatment).

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. A particular embodiment need not provide all features noted above, nor solve all problems or address all issues in the background noted above.

### BRIEF DESCRIPTION OF THE DRAWINGS

The description herein makes reference to the accompanying drawings wherein like reference numerals refer to like parts throughout the several views, and wherein:

FIG. 1A is a schematic hydraulic diagram of a source water treatment system according to common osmotic membrane bioreactor systems.

FIG. 1B is a schematic hydraulic diagram of a source water treatment system according to the first example.

FIG. 1C is a schematic hydraulic diagram of a source water treatment system according to the second example.

FIG. 1D depicts water flux as a function of time during one month of testing of an embodiment of the disclosed system, wherein sludge is introduced after 42 hours of operation with tap water feed, and the draw solution concentration was constant throughout the first month of operation at about 32 g/L NaCl.

FIG. 1E depicts water flux as a function of time during a second month of testing the embodiment depicted in FIG. 1D, wherein elevated and lowered flux at ˜480 and ˜250 correspond to MLSS temperatures of 21° C. and 11° C., respectively.

FIG. 1F depicts mixed liquor suspended solids (MLSS, in g/L) and solids retention time (SRT, in days) vs. time (in days) of the embodiment depicted in FIG. 1D.

FIG. 1G depicts conductivity (in mS/cm) and DS conductivity (in mS/cm) vs. time (in days) of the embodiment depicted in FIG. 1D.

FIG. 1H depicts total phosphorous (TP, in mg/L-P) vs. time (in days) of the embodiment depicted in FIG. 1D.

FIG. 1I depicts Ammonia (NH₃, in mg/L-N) concentration vs. time (in days) of the embodiment depicted in FIG. 1D.

FIG. 1J depicts Nitrate (NO₃, in mg/L-N) concentration vs. time (in days) of the embodiment depicted in FIG. 1D.

FIG. 1K depicts chemical oxygen demand (COD, in mg/L) vs. time (in days) of the embodiment depicted in FIG. 1D.

FIG. 2 depicts a conventional BNR and Struvite recovery process configuration.

FIG. 3 depicts a microfiltration/ultrafiltration (MF/UF) MBR with BNR and Struvite recovery process configuration.

FIG. 4 depicts one embodiment of a system that incorporates the presently disclosed processes and methods.

FIG. 5 depicts one embodiment of a system that incorporates the presently disclosed processes and methods.

FIG. 6 depicts one embodiment of a system that incorporates the presently disclosed processes and methods.

FIG. 7 depicts one embodiment of a system that incorporates the presently disclosed processes and methods.

FIG. 8 depicts one embodiment of a system that incorporates the presently disclosed processes and methods.

FIG. 9 depicts one embodiment of a system that incorporates the presently disclosed processes and methods.

### DETAILED DESCRIPTION

Disclosed herein are processes, methods, and systems for the processing of impaired water, for example, wastewater and, in some cases, seawater. In some embodiments, the processes described herein provide for production of various grades of water (including potable and non-potable water), solid waste products, and other useful products, for example, fertilizers and/or struvite.

The disclosed processes, methods, and systems include steps or acts that may form, at least in part, a system for treating wastewater and/or seawater. In some embodiments, the present disclosure is directed to the production of biological nutrients from wastewater. In some embodiments, the present disclosure is directed to the production of biological nutrients in addition to potable and non-potable water. In some cases, the present disclosure includes one or more of the following processes, methods, steps, or units: clarification, bioreactor, permeable membrane, microporous membrane, aerobic digestion, re-concentration, biological nutrient recovery, and struvite precipitation.

Water treatment systems that use the disclosed processes and methods may include one or more vessels or tanks for holding and/or treating the water and one or more pumps for transferring water/fluid between the tanks. In one embodiment, wastewater may be directed to a bioreactor tank, wherein the tank is configured to allow for growth of biological organisms, such as bacteria or protozoa. In various embodiments, the bioreactor tank may further comprise a semi-permeable and/or a microporous membrane. In many embodiments, water may pass through the semi-permeable membrane while dissolved solids and suspended solids may be rejected. This may cause the concentration of dissolved solids in the wastewater to increase. Water and dissolved solids may pass through the microporous membrane. Thus, two permeate streams (fluid passing through the membrane) may be produced from the bioreactor: a semi-permeable membrane permeate and a microporous membrane permeate. Wastewater with high concentration of suspended solids may remain in the bioreactor.

In various embodiments, the bioreactor can be operated as a sequencing batch reactor (SBR) wherein aerobic, anoxic, or anaerobic processes can be achieved sequentially and cyclically by varying the supply of oxygen (e.g., from air) over time or by intermittently turning the oxygen ON or OFF as required. In some embodiments, operating the reactor as a sequencing batch reactor may allow aerobic, anoxic, or anaerobic conditions to be achieved in a sequential and/or cyclical manner in one or more tanks of the disclosed treatment system.

The SBR mode can be achieved in configurations where the porous and semipermeable membranes are submerged. It can also be achieved in crossflow configurations as follows: For the SBR configurations, when the membranes are in submerged configuration, they may or may not be located in the tank where the air flow is varied sequentially and cyclically. In these embodiments, the porous (MF or UF) membranes and/or the semipermeable (forward osmosis, FO) membranes are located outside the bioreactor and the feed contents are circulated across the feed side of the membranes with crossflow achieved by pumping the feed or by using an air-lift mechanism which uses air introduced in the feed to induce feed flow. In some embodiments, the semipermeable and/or porous membrane filter units may be located in a separate tank.

In some embodiments, wastewater may be treated before it enters the bioreactor. The wastewater treatment may be clarification and/or biological nutrient recovery. In some cases, clarification may reduce the concentration of suspended matter in the wastewater. In some embodiments, the suspended matter removed from the wastewater in the clarification step may be referred to as clarifier sludge. In some embodiments, clarifier sludge may be added to an anaerobic digester to aid in removal or recovery of biological nutrients from the sludge.

The semi-permeable membrane may be a forward osmosis membrane. In some embodiments, the forward osmosis process may require a draw solution, for example a brine with a greater osmotic pressure than the wastewater. In some embodiments, the draw solution may be seawater. In many embodiments, the draw solution may be diluted by the semi-permeable membrane permeate. In some embodiments, the diluted draw solution may be discarded, collected, and/or treated. In some embodiments, diluted draw solution may be treated by reverse osmosis to create (1) a potable or non-potable water and/or (2) a re-concentrated brine solution. In some embodiments, this re-concentrated brine solution may have an osmotic pressure similar to that of the draw solution. The re-concentrated brine solution may be discarded, re-used as draw solution, and/or used in other processes (for example, beneficial purposes such as road salting, hydraulic fracturing, or any other use of diluted brine).

Microporous membrane permeate may include dissolved solids. Dissolved solids may include ammonia (NH₃) and phosphate (PO₄) that can be recovered. In some cases, nitrogen and phosphorous containing compounds will be precipitated in a struvite reactor. Prior to entering a struvite reactor, the microporous membrane permeate may be treated by addition of various compounds, for example magnesium oxide (MgO) and/or phosphoric acid (H₃PO₄).

In some embodiments, the disclosed process may include an anaerobic digester. The anaerobic digester may be configured to release nitrogen and/or phosphorous containing compounds from a sludge. The sludge in the anaerobic digester may be clarifier sludge and/or sludge from the bioreactor. The anaerobic bioreactor may produce an effluent. The effluent may be treated by a separator to produce a solid and liquid streams. In some embodiments, the separator is a belt thickener. In some cases, the liquid produced by the separator may be referred to as pressate. In various embodiments, the pressate may be combined with the microporous membrane permeate prior to the microporous membrane permeate being treated in the struvite reactor. In some embodiments, the solid matter produced by the separator may be referred to as separator sludge. In some embodiments, the separator sludge may be discarded or used for a beneficial purpose such as for energy generation or as a solid fertilizer.

The struvite reactor may produce struvite and a liquid effluent. In some embodiments, struvite from the struvite reactor may be used as agricultural fertilizer. In some embodiments the liquid effluent from the struvite reactor may be discharged, or treated further. Where the struvite effluent is treated further, the treatment may reduce the concentration of phosphorous and nitrogen containing compounds. In some embodiments, zeolite ion exchange systems may be used to remove ammonia from the struvite reactor effluent. The zeolite used in the ion-exchange systems may be clinoptiloite. In some embodiments ammonia in the struvite reactor effluent may be removed by converting to nitrogen gas using the Anammox process. In some embodiments, ferric oxide or alum may be added to the struvite effluent to aid in precipitating out phosphorous containing compounds.

The disclosed process may optionally include a biological nutrient recovery/removal step. In various embodiments, the biological nutrient recovery/removal step may aid in reducing or removing one or more of phosphorous containing compounds, nitrogen containing compounds, and biochemical oxygen demand in the wastewater. In many embodiments, the biological nutrient recovery/removal step may be prior to the bioreactor step. In many embodiments, the biological nutrient recovery/removal step is after the clarifier step. In many embodiments, the biological nutrient recovery/removal step is after the step involving treatment of waste activated sludge by anaerobic treatment. In some embodiments, the biological nutrient recovery step may remove phosphorous containing compounds in an anaerobic reactor/tank. In some embodiments, nitrogen removal may be through a process of denitrification and nitrification. In some embodiments, nitrification may occur in an aerobic environment and denitrification may occur in an anoxic environment, for example in an anoxic reactor/tank. In many cases, biological nutrient recovery may occur in three steps: an anaerobic reactor/tank to remove phosphorous containing compounds, an anoxic reactor/tank for denitrification, and an aerobic reactor/tank for nitrification, which may also reduce or remove biochemical oxygen demand. In some embodiments, these steps may occur sequentially in three separate reactors/tanks, with treated liquid being pumped from one tank to the next.

Embodiments of the present disclosure provide methods for purifying a liquid, such methods acting, for example, to reduce its solute load. In particular implementations, the liquid to be purified is seawater, brackish-water, impaired-water, wastewater, or other source (generally referred to as source water). In further implementations, the source water is purified to a potable level.

In one aspect, systems are provided for purifying a liquid, such as source water. In one example, the system includes a water purification unit, such as a desalination unit, in combination with a forward-osmosis unit that dilutes a draw solution stream entering the desalination unit. The forward-osmosis unit is located hydraulically upstream of the desalination unit and is configured to receive a stream of draw solution from the desalination unit. The draw solution passes through the forward-osmosis unit on a receiving side of a semipermeable membrane in the forward-osmosis unit. Meanwhile, a source water stream having a relatively low osmotic potential (e.g., a liquid having a low salinity compared to the high salinity draw solution) passes through the forward-osmosis unit on the feed side of the forward-osmosis membrane, which results in a net transfer of water through the membrane from low osmolality source water to the draw solution, diluting the draw solution. In a particular implementation, the resulting diluted source water is used as a feed for the desalination unit. By diluting the feed stream entering the desalination unit, the energy expenditure (per unit of product water) of the desalination unit may be reduced. The desalination unit produces a stream of product water and a stream of brine concentrate.

A further example of the system may include the components of the previous example and further include a treatment unit located upstream or downstream of the forward-osmosis unit. The treatment unit treats the source water before or after the source water passes through the forward-osmosis unit. In particular implementations, the treatment unit reduces the particulate or solute load (or both) of the source water. In certain examples, the treatment unit is configured to perform one or more of coagulation, biological oxidation, biological nitrification, biological nitrification-denitrification, anaerobic digestion, filtration, ion-exchange, chemical addition, and other membrane process, in any suitable order.

In a particular implementation, the treatment unit is a fully mixed reactor or a bioreactor. In further implementations, the treatment unit is a baffled reactor. In yet additional implementations, liquid, solid, or gaseous chemicals might be added to the treatment process.

In another example, the system includes the components in the first described embodiment as well as a microfiltration or ultrafiltration membrane system situated hydraulically parallel to the forward-osmosis unit, in the same holding tank/reactor. The forward-osmosis system receives a stream of draw solution (such as concentrated brine from the desalination unit) from the water purification unit, dilutes the concentrate, and optionally returns the diluted concentrate to the water purification unit. Simultaneously, the microporous membrane system draws water and many dissolved constituents from the common holding tank of the two membranes, producing purified water suitable for most non-potable applications.

As a result, the chemistry and biological conditions in the source water of the mutual holding tank/reactor may be controlled. Furthermore, purified water of different quality (both potable and non-potable) may be produced simultaneously by one hybrid system.

The parallel microporous membrane system may be operated to extract useful constituents from the source water in the mutual holding reactor. In a particular implementation, a resource recovery system may be used to extract dissolved constituents from the permeate water of the microporous microfiltration or ultrafiltration membrane. In a further implementation a desalination process such as reverse osmosis, nanofiltration, electrodialysis, or other separation processes may be used to recover clean water from the microporous membrane permeate stream and concentrate one or more dissolved constituents. In specific implementations, liquid, solid, or gaseous chemicals might be added to the resource recovery system to facilitate resource recovery.

In further implementations, the a side stream of the mutual holding tank/reactor may be directed to an energy and/or resource recovery unit for further recovery of resources such as nutrients or minerals and simultaneous generation of energy for biogases, biosolids, or bioliquids.

According to a further example, the method and system may be similar to the previous example but includes a source of draw solution for the forward-osmosis unit having high osmotic pressure instead of a water purification unit. The source of draw solution may be, for example, seawater, hypersaline reservoir/lake, industrial brine, or any other source of high osmotic pressure liquid. In a particular implementation, the high osmotic pressure stream may be diluted before further processing of the stream. In a further implementation, the diluted stream may be used for other beneficial purposes such as road salting, hydraulic fracturing, or any other use of diluted brine.

The above-described systems and/or related methods may be used for processes other than the desalination of seawater and treatment of wastewater. Other processes may include desalination of brackish water, concentration of foods or beverages, and concentration or purification of chemical or pharmaceutical products.

The disclosed process presented represents a significant improvement over state of the art methods of biological nutrient removal while improving quantity, yield, purity, and efficiency of the recovered fertilizer.

The disclosed process/system consists of a hybrid MBR comprising of osmotic (semipermeable) and porous (microfiltration or ultrafiltration) membranes and is operated in a mode that allows more efficient removal of nitrogen and phosphorus from wastewater by combining fertilizer recovery methods while operating the bioreactor either with biological nutrient removal (anoxic and/or anaerobic treatment) or without biological nutrient removal (without anoxic and/or anaerobic treatment).

There are additional features and advantages of the subject matter described herein. They will become apparent as this specification proceeds.

In this regard, it is to be understood that this is a brief summary of varying aspects of the subject matter described herein. The various features described in this section and below for various embodiments may be used in combination or separately. A particular embodiment need not provide all features noted above, nor solve all problems or address all issues in the background noted above.

The presently disclosed processes, methods, and systems may aid in the treatment of wastewater and the production of potable water, non-potable water, and recovery of beneficial nutrients.

### Terms

The following terms are used herein:

“Seawater” is saline water from the sea or from any source of brackish water.

“Source water” is water, such as domestic wastewater, or industrial wastewater, or useful liquid requiring concentration, or any impaired stream requiring treatment. It may also be seawater or lake water or reservoir water, input to a treatment process such as a wastewater treatment or concentration process.

“Impaired Water” is any water that does not meet potable water quality standards.

“Concentrate” is a by-product of a water treatment process having a higher concentration of a solute or other material than the feed water, such as a brine by-product produced by a desalination or a concentration process.

“Draw solution” is a solution having a relatively high osmotic potential that may be used to extract water from a solution having a relatively low osmotic potential through a semi-permeable membrane. In certain embodiments, the draw solution may be formed by dissolving an osmotic agent in water or different solvent.

“Receiving stream” is a stream that receives water by a water purification or extraction process. For example, in forward-osmosis, the draw solution is a receiving stream that receives water from a source water feed stream having a lower osmotic potential than the receiving stream.

“Anaerobic” refers to an environment with low levels of oxygen. In many cases, low oxygen levels are less than about 1 mg/L of dissolved oxygen. In many cases, an anaerobic water environment has 0.2 mg/L or less of dissolved oxygen. In some cases, an anaerobic environment may be referred to as an anoxic environment. In some cases, an anaerobic environment may lack oxygen and other electron acceptors.

“Aerobic” refers to an environment containing oxygen. In many cases, aerobic water environments contain greater than about 1 mg/L of dissolved oxygen.

“Biological Nutrient Removal” or “BNR” may refer to processes using biological organisms to remove chemicals and/or compounds from a source water. The source may or may not contain biological organisms, for example microbes. In some cases, biological organisms and/or various chemicals and compounds, for example volatile organic acids, methanol, alkaline compounds, can be added to the source before or during biological nutrient removal. BNR may include nitrification and de-nitrification and anaerobic treatment.

“Hybrid MBR” may refer to a bioreactor comprising a semi-permeable membrane unit and a microporous membrane unit. In some embodiments, the semi-permeable membrane unit may be a forward osmosis unit (OMBR), and the microporous membrane unit may be a microfiltration and/or ultrafiltration unit (MBR).

In addition, the terms “upstream”, “downstream”, and “parallel” are used herein to denote, as applicable, the position of a particular component, in a hydraulic sense, relative to another component. For example, a component located upstream of a second component is located so as to be contacted by a hydraulic stream (flowing in a conduit for example) before the second component is contacted by the hydraulic stream. Conversely, a component located downstream of a second component is located so as to be contacted by a hydraulic stream after the second component is contacted by the hydraulic stream. It is possible that there can be recirculation of fluid from the downstream component to the upstream component and vice versa.

In one application, the disclosed methods may be used to treat impaired water to make it reusable.

The disclosed systems and methods may be implemented in any suitable manner, which may depend on the particular application, including the scale of the application. The various components, such as heat exchangers and purification units, may be made of suitably non-reactive materials such as concrete, cement, plastic, stainless steel, composite materials such as fiberglass, and glass. Liquid sources or other vessels may be, without limitation, cylindrical tanks, water towers, contoured tanks, or fitted tanks.

### Treatment System

The disclosed processes, methods, and steps may be included in a water treatment system. The disclosed water treatment system includes a plurality of vessels or tanks for holding and treating liquids, conduits for transporting liquids (including sludge) to and from the tanks, and pumps for aiding the transport of liquids, circulating liquids, and pressurizing liquids. The disclosed system includes a bioreactor tank fluidly connected to a wastewater source. The bioreactor tank may be fluidly connected to one or more processing units that may or may not be located in a separate vessel, for example a clarifier unit, an aerobic reactor, an anaerobic reactor, an anoxic reactor, an aerobic digester, a separator, a forward osmosis unit, a porous filtration unit, a reverse osmosis unit, and/or a recirculation unit.

Reactor units may include a plurality of inputs and outputs for transferring liquids to and from the reactor, adding compounds to the reactor, monitoring the liquid in the reactor, and or treating the liquid in the reactor. The system, including conduits (e.g. pipes), vessels, tanks, reactors, units and other components may comprise any suitable material for processing of wastewater, seawater, and/or potable and non-potable water.

### Bioreactor

The disclosed bioreactor may include a tank, temperature control devices, a mixing device, and an aeration device. In many cases the tank may be configured to accept a liquid, for example wastewater or impaired water. The tank may be created of any suitable material, and the material may be treated and or coated to aid in the process of wastewater treatment. In some embodiments, the liquid in the bioreactor includes suspended solids, dissolved solids and other components. In some embodiments, the wastewater or impaired water has been clarified and/or processed to remove a portion of the biological nutrients prior to entering the bioreactor.

The mixing device may be configured to mix and combine the liquid contents of the tank. In most cases the tank may be configured to prevent gases from leaving the tank. In some cases, the tank may have one or more input ports and one or more outflow ports designed to allow a gas, solid, or liquid to enter the tank or exit the tank. One outflow port may be designed to allow a liquid to exit the tank. In some embodiments, the disclosed tank may further include an outflow port, or discharge element, designed to allow a liquid with a high concentration of solids or suspended solids, for example sludge, to exit the tank. In some embodiments, biological organisms and/or chemicals may be introduced into the tank, and mixed with the liquid. In many cases, the temperature of the tank and its contents may be controlled by methods and devices that are well known in the art.

The aeration device may be configured to inject air or other gases into the tank. In some embodiments, the air may be injected directly into the liquid below the surface of the liquid. In many cases, the composition of the air or gases injected into the liquid may be controlled, for example to increase or decrease the oxygen content.

The bioreactor may be an aerobic reactor or an anaerobic reactor. In some embodiments, the bioreactor is an aerobic reactor that oxidizes organic carbon and hydrogen without oxidizing nitrogen, thus removing only the carbonaceous biochemical oxygen demand (cBOD). In some cases, the bioreactor further includes an anoxic reactor for denitrification and an anaerobic reactor for phosphorous removal.

In various embodiments oxidation of organic nitrogen and ammonia (nitrification) may be at least partially prevented by one or more of the following methods, operating the system as a High Rate Activated Sludge Process, or partial or complete inhibition of the growth of one or more microbes. In various embodiments, the solids retention time (SRT) and hydraulic retention time (HRT) of the system may be chosen to obtain high chemical oxygen demand to microorganism ratio (COD/M ratio) and minimal or no nitrification. In some embodiments, the solids retention time is between about 12 hours and 8 days, preferably between 3 days and 5 days. In some embodiments, the hydraulic retention time is between about 1 hour and 12 hours, preferably between about 3 hours and 6 hours. In some embodiments, the chemical oxygen demand to microorganism ratio is between about 0.4 kg and 2.5 kg of chemical oxygen demand per kg of mix liquor volatile suspended solids (kg COD/kg MLVSS), preferably in the range of 1 to 2 kg COD/kg MLVSS.

In some cases, the one or more inhibited microbe is nitrosomonas ammonia oxidizing bacteria (AOB) and/or nitrobacter nitrite oxidizing bacteria (NOB). In various embodiments, the one or more microbes is inhibited by addition of one or more chemical inhibitors, or modifying one or more physical or physico-chemical operating parameters. In some embodiments, the chemical inhibitors may be organic compounds, inorganic compounds, or metals, wherein the chemical inhibitor completely or partially inhibits the growth of the AOB or the NOB. In various embodiments, the chemical inhibitor compounds are selected from the group consisting of 2-chloro-6-(trichloromethyl)-pyridine, 5-ethoxy-3-trichloromethyl-1,2,4-thiadiazol, Dicyandiamide, 2-amino-4-chloro-6-methyl-pyrimidine, 2-mercapto-benzothiazole, 2-sulfanilamidothiazole, Thiourea, 2,4-diamino-6-trichloromethyl-5-triazine, Polyetherionophores, 4-amino-1,2,4-triazole, 3-mercapto-1,2,4-triazole, Potassium azide, Carbon bisulfide, Sodium trithiocarbonate, Ammonium dithiocarbamate, 2,3, dihydro-2,2-dimethyl-7-benzofuranol, Methyl-carbamate, N-(2,6-dimethylphenyl)-N-(Methoxyacetyl), Alanine methyl ester, Ammonium thiosulfate, 1-hydroxypyrazole, 2-methylpyrazole-1-carboxamide, Acetone, Phenol, Carbon Disulfide, Ethylenediamine, Chloroform, Hexamethylene Diamine, Ethanol, Aniline, Monoethanolamine, Sodium Cyanide, Free Cyanide, Sodium Azide, Perchlorate, Hydrazine, Sodium Cyanate, Potassium Chromate, Chromium Cadmium, Silver Fluoride, Thiocyanate, Zinc, Copper, Mercury, Nickel, Arsenic (trivalent), Cobalt, and Lead. In some embodiments, the one or more physical or physico-chemical operating parameters may be pH, temperature, dissolved oxygen, salinity, total dissolved solids, alkalinity, or a combination thereof.

Where the bioreactor is an anaerobic or anoxic reactor, or includes an anaerobic or anoxic reactor, the bioreactor may be sealed off from the ambient environment, that is the bioreactor, anaerobic reactor, or anoxic reactor may be air-tight. In some embodiments, the reactor may include a headspace between the top of a liquid and the wall of the bioreactor. In these cases, a biogas may be collected in the headspace.

In some cases, the addition of air and/or biological organisms, such as bacteria or protozoa, may help produce a waste activated sludge. In many embodiments, the waste activated sludge may be removed from the bioreactor for processing downstream in an anaerobic digester.

The bioreactor may further include a semipermeable membrane device and/or a porous membrane device. In some embodiments, the semipermeable membrane device and/or the porous membrane device may be located within or outside the bioreactor tank. In embodiments where the semipermeable membrane device and/or porous membrane device is located outside the bioreactor, fluid from within the bioreactor may be drawn into the membrane device where the fluid is treated and a portion of the fluid having a higher concentration of suspended solids may be returned to the bioreactor tank. In some embodiments, the semipermeable membrane device and/or porous membrane device may be operated in parallel within the bioreactor. In some embodiments, the parallel devices may not be operated simultaneously, to allow accumulation of specific constituents within the fluid or liquid, for example organic compounds, nutrients, or other constituents of interest that may be extracted and/or recovered when the semipermeable membrane device or porous filtration device is operated.

In various embodiments, the bioreactor may include a semipermeable membrane device and/or porous membrane device submerged in a liquid contained in the bioreactor. In other embodiments, the devices are configured as crossflow (external) membrane devices. In these embodiments, the porous (MF or UF) membranes and/or the semipermeable (FO) membranes may be located outside the bioreactor tank. Where the membrane devices are located outside the bioreactor tank, the liquid of the bioreactor may be circulated across the feed side of the membranes by pumping the feed or by using an air-lift mechanism which uses air introduced in the feed to induce feed flow.

### Semipermeable Membrane

The presently disclosed system may include a semipermeable membrane positioned within the bioreactor. In some embodiments, the semipermeable membrane positioned within the bioreactor may be referred to as an osmotic membrane and the bioreactor may be referred to as an osmotic membrane bioreactor, OMBR. In some cases, the semipermeable membrane in the bioreactor is a forward osmosis membrane. The forward osmosis membrane may be part of a forward osmosis membrane unit that is at least partially submerged in the liquid within the bioreactor tank. The forward osmosis unit may be designed to extract water from the tank while preventing the extraction of dissolved solids, suspended solids, and other compounds. In many embodiments, the solids and compounds that are at least partially rejected by the semipermeable membrane may be controlled by selection and design of the membrane used in the semipermeable membrane unit.

In some embodiments, the forward osmosis unit may comprise a plurality of channels. In some embodiments, the channels are configured to place draw solution in proximity to the draw side of the semipermeable membrane.

Semi-permeable membranes may aid in removing total dissolved solids (TDS) and suspended solids from a fluid. For example, a semi-permeable membrane may aid in preventing passage of some or all dissolved solids and some or all suspended solids across the semi-permeable membrane. Where a semipermeable membrane unit is submerged within a liquid in a tank the semipermeable membrane may aid in removing water from the liquid while preventing the removal of dissolved solids and suspended solids, thus increasing the concentration of suspended and dissolved solids within the liquid in the tank. Semipermeable membranes may, therefore, separate a liquid into a first portion having a low concentration of dissolved solids and a low concentration of suspended solids, and a second portion having a high concentration of dissolved solids and a high concentration of suspended solids.

In some embodiments, a semipermeable membrane may be referred to as a high TDS and high total suspended solids, TSS, removing mechanism. The amount of dissolved solids and/or suspended solids allowed to pass through a semipermeable membrane may vary. In some cases, the amount of dissolved solids and/or suspended solids allowed to pass through a semipermeable membrane may be dependent on the type of membrane or the semipermeable membrane units selected. For example, in some cases, a particle with a size that is significantly greater than the pore size of a membrane may be able to reject about 100% of the particles, while for particles with a size that is equal to or smaller than the pore size of the membrane, rejection may be less than about 100%. In some cases, for example MF and UF membranes, there is about 0% or negligible (less than about 1%) rejection of TDS. In some cases, for example RO and NF membranes, rejection of TDS can vary from 85% to 99.7% depending on the membrane type (RO or NF) and the nature of the dissolved solid (i.e. monovalent or divalent ions, organic or inorganic, polar or non-polar, etc.). In the case of rejection of suspended solids, semipermeable membranes may achieve about 100% rejection of TSS, while MF and UF membranes may remove suspended solids based on their particle size. For particles significantly greater than the pore size of the MF/UF membrane, this can be 100%, for particles equal to or lower than the pore size, it can be slightly or significantly lower than 100%.

Devices that may be used to separate and exclude dissolved solids and suspended solids within a liquid may include a forward osmosis (FO) device, a reverse osmosis (RO) device, a nanofiltration (NF) device, or other device known in the art. In some embodiments, membranes for RO and FO may have a separation range from about 1 Angstrom (Å) to about 15 Å, nanofiltration membranes may have a separation range from about 9 Å to about 80 Å, UF membranes may have a separation range from about 30 Å to about 1.2 k Å, and MF membranes may have a separation range from about 5 k Å to about 30 k Å.

Forward osmosis may use various solvents to aid in drawing water and other compounds across the semipermeable membrane. This solvent may be referred to as a draw solution. In some embodiments, the draw solution for the forward osmosis (FO) process, the FO draw solution, is seawater or a brine solution. In one embodiment, the seawater may be diluted by forward osmosis process to produce a diluted seawater. In some embodiments, the diluted seawater can be discharged into the environment, used in various beneficial products, and/or processed by reverse osmosis.

A forward-osmosis process is termed “osmosis” or “direct osmosis.” Forward-osmosis typically uses a semipermeable membrane having a permeate side and a feed side. In most cases, the feed (active) side contacts the water (source or feed water) to be treated. The permeate (support) side contacts a hypertonic solution, referred to as an osmotic agent or a draw solution or receiving stream, that serves to draw (by osmosis or a combination of osmosis and convective flow by hydraulic pressure) water molecules and certain solutes and other compounds from the feed water through the membrane into the draw solution. The draw solution is circulated (or flowing) on the permeate side of the membrane as the feed water is passed by the feed side of the membrane. Unlike reverse osmosis, which uses a pressure differential across a somewhat similar semi-permeable membrane to induce mass-transfer across the membrane from the feed side to the permeate side, forward-osmosis uses an osmotic-pressure difference (or water activity difference) between the feed stream and draw solution as the driving force for mass transfer across the membrane. As long as the osmotic pressure of water on the permeate side (draw solution side) of the membrane is higher (i.e., water activity is lower) than the osmotic pressure of water on the feed side, water will diffuse from the feed side through the membrane and thereby dilute the draw solution. To maintain its effectiveness in the face of this dilution, the draw solution is typically re-concentrated, or otherwise replenished, during use. This re-concentration typically consumes most of the energy that conventionally must be provided to conduct a forward-osmosis process. In particular implementations, the feed water is concentrated and the draw solution is ultimately diluted and discharged or further processed.

Because the semipermeable membranes used in forward-osmosis are typically similar to the membranes used in reverse osmosis, most contaminants are rejected by the membrane and only water and some small ions or molecules diffuse through the membrane to the draw solution side. A contaminant that is “rejected” is prevented by the membrane from passing through the membrane. Selecting an appropriate membrane usually involves choosing a membrane that exhibits high rejection of salts as well as various organic and/or inorganic compounds while still allowing a high flux (throughput) of water through the membrane at a high or low osmotic driving force.

Other advantages of the forward-osmosis process may include relatively low propensity to membrane fouling, low energy consumption, simplicity, and reliability. Because operating hydraulic pressures in the forward-osmosis process typically are very low (up to a few bars, reflective of the flow resistance exhibited in the flow channels of a membranes module or element), the equipment used for performing forward-osmosis may be very simple. Also, use of lower pressure may alleviate potential problems with membrane support in the housing, reduced fouling of the membranes due to lower compaction of foulants onto membrane surface, and choice of exotic materials for pressure vessels, valves, controls, and instrumentation that would otherwise be necessary for high pressure operation.

Forward osmosis membranes for use in the disclosed processes, methods, and systems may be cleaned. In some embodiments, the mechanism for cleaning a semipermeable membrane employs an osmotic backwashing process, wherein the draw solution is replaced with fresh water that recirculates on the receiving side of the forward osmosis membrane and water diffuses through the membrane into the source water side of the forward osmosis membrane, thus removing fouling from the source side of the forward osmosis membrane. In further embodiments, the membrane may be cleaned using a mechanism that may include a biphasic fluid flow consisting of a mixture of fluid contents and gas, or a cross flow of the fluid contents across the membrane surface. In some embodiments, the tank containing the semipermeable membrane system may be sealed from the atmosphere and the gas for use in the biphasic fluid flow may be drawn from the headspace of the tank.

In one application, the disclosed methods may be used to treat impaired water to make it reusable. The disclosed methods may also be used in the treatment and concentration of hypersaline feed water.

### Draw Solution

The disclosed processes and steps may include a draw solution for use in the forward osmosis unit. The draw solution for the forward osmosis unit may be obtained from various sources, natural and non-natural, and may be referred to as a FO draw solution. In some embodiments, the FO draw solution may be obtained from one or more of the following: seawater from open ocean, estuary or bay, brine, concentrate from an RO system, concentrate from an NF system, or any water or wastewater which has osmotic pressure higher than that of contents of the treatment system. In some embodiments, the draw solution may be an organic compound, an inorganic salt, organic salt, magnetic nanoparticles, and particles with super hydrophilic moieties such as polyelectrolytes that may be filtered by pressure driven processes.

In some cases, the draw solution may be from a water purification unit, in other embodiments, the draw solution may have high osmotic pressure. In some embodiments, the draw solution may be seawater, hyper-saline reservoir/lake water, industrial brine, similar high osmotic pressure liquid, or a combination thereof. In some embodiments, the high osmotic pressure draw solution may be diluted by water flowing through the forward osmosis semipermeable membrane. In some embodiments, the diluted draw solution may produce a stream that may be used for other beneficial purposes such as road salting, hydraulic fracturing, or any other suitable use of diluted brine.

Diluted draw solution may be treated in various ways. In some embodiments the diluted draw solution may be re-concentrated. Re-concentration may be performed in various ways, for example by reverse osmosis, nanofiltration, distillation, electrodialysis, thermal decomposition of salt such as ammonium bicarbonate from their solutions into gases followed by resolubilization of the gases to form salt solutions, precipitation, membrane distillation, solvent polarity switching, magnetic separator, or other equivalent technology.

In various embodiments, diluted draw solution may be processed by reverse osmosis to produce potable or non-potable water. In many embodiments, diluted draw solution is processed by reverse osmosis to desalinate the diluted draw solution. In some embodiments, for example where the draw solution is seawater, dilution of the seawater by forward osmosis will allow reduction in the osmotic pressure of the seawater and therefore reduce the cost of desalinating the water to produce potable water. Use of diluted seawater in the reverse osmosis process may help to operate the reverse osmosis process with lower energy consumption and/or at a higher volumetric recovery compared to reverse osmosis desalination of undiluted seawater. In addition, dilution of seawater draw solution results in lower salinity and consequent lower pressure RO operation, which may allow the use of cheaper material of construction for pumps, piping, and process equipment instead of the expensive high grade stainless steel typically required for high salinity seawater desalination.

The disclosed process, therefore may be beneficial for wastewater treatment, for example those in coastal areas. Use of diluted seawater draw solution in reverse osmosis offers a method that may be more energy-efficient and/or may result in higher recovery of desalinated water. Overall, use of the disclosed processes may result in desalination and wastewater treatment that may have a lower carbon footprint than current methods. The disclosed processes can also be useful in cruise ships where fuel consumption (energy), footprint, chemical provisions, and system productivity are key design constraints.

The above-described systems and/or related methods may be used for processes other than the desalination of seawater and treatment of wastewater. Other processes may include desalination of brackish water, concentration of foods or beverages, and concentration or purification of chemical or pharmaceutical products.

### Reverse Osmosis

The disclosed process may include a reverse osmosis step or unit. Reverse-osmosis, like forward osmosis, typically uses a semipermeable membrane having a permeate side and a feed side. However, reverse osmosis is the process of forcing a solvent in the opposite direction (compared to forward osmosis), from a region of high solute concentration through the semipermeable membrane to a region of low solute concentration. This is done by applying pressure to the high-solute concentration solvent, in excess of its osmotic pressure. Reverse osmosis, therefore, can be used in obtaining pure water from seawater and brackish waters. For example, seawater is pressurized against one surface of the semipermeable membrane, which prevents transport of salt, but allows permeation of water across the membrane, resulting in potable drinking water on the low-pressure side. This process can also be referred to as desalination.

In various embodiments, reverse osmosis may be used after forward osmosis. In some cases, the reverse osmosis permeate stream may be potable or non-potable (e.g. process) water. In some embodiments the reverse osmosis permeate stream may be further treated, for example by UV irradiation and or ozone treatment, electrodeionization (EDI), reverse EDI, capacitive deionization (DI). The use of two semi-permeable membranes (FO and RO) may produce a water wherein the concentration of compounds such as endocrine disrupting chemicals (EDCs) may be lower compared with other methods.

Diluted draw solution produced by the forward osmosis process may be subjected to reverse osmosis. The reverse osmosis process may produce a permeate (RO permeate) and a concentrate (RO concentrate). In various embodiments, depending upon the type of reverse osmosis membrane used, the RO permeate may be potable water or non-potable water. In many embodiments, the non-potable water may be process water suitable for various uses other than drinking, for example process water may be used in various industrial processes. The RO concentrate may be discharged into the environment and/or recycled for use in the forward osmosis process, as the FO draw solution.

Reverse osmosis (RO) can be used to obtain potable and non-potable (process) water directly from seawater, which is referred to as seawater reverse osmosis, or SWRO. Although SWRO may help to provide a reliable means of producing potable and non-potable water for coastal areas, it has several disadvantages, especially cost. For example, SWRO has high operating cost associated with the high pressures necessary for operation. The use of seawater can require operating pressures of the order of 900 psig or more. In some cases, for example where the salinity is high, these operating pressures can be higher, for example, some seawater in the Middle East can be as high as 45,000 mg/L instead of the average seawater salinity of 35,000 mg/L. High salinity seawater, because of its corrosive properties, can also necessitate the use of exotic and expensive alloys for construction materials. Moreover, elevated salinity may also limit the volumetric recovery for SWRO (i.e., the percent of seawater feed that is recovered as permeate) and increase scaling. Thus, increased salinity can significantly increase the capital cost of systems that produce water from seawater through reverse osmosis. One alternative is to use wastewater to produce water from reverse osmosis.

One alternative to the use of seawater to produce potable and non-potable water involves the treatment of wastewater to produce brackish water, which is then processed by reverse osmosis. In one case, wastewater is first treated by a biological method followed by UF/MF filtration and the resulting permeate submitted to reverse osmosis. Typically this type of treatment process involves either a ultrafiltration/microfiltration membrane bioreactor (UF/MF MBR) followed by reverse osmosis (MBR+RO) or a conventional activated sludge plant followed by UF/MF followed by RO (ASP+UF/MF+RO).

The lower energy cost associated with the use of brackish water for reverse osmosis was proposed as the main advantage of these processes in replacing the SWRO process. However, there are still disadvantages associated with the production of brackish water for use in reverse osmosis processes. Some of the disadvantages of producing brackish water include, biofouling of reverse osmosis membranes.

Reverse osmosis membranes may be fouled by a variety of compounds. For example, biofouling may be caused by the presence of nitrogen and/or phosphorus containing compounds in the filtration membrane permeate (especially where nitrogen and phosphorus are not removed), and biofouling of reverse osmosis membranes caused by biological oxygen demand in the filtration membrane permeate. In some cases the biological oxygen demand is elevated due to upsets in biological process that result in the release of extracellular polymeric substances (EPS, which can also foul the reverse osmosis membranes).

The addition of chloramines into a permeate stream can help in controlling biofouling. However, this control strategy is not always effective and can add complexity to process control. Moreover, addition of oxidative chemicals (such as chlorine, which reacts with ammonia to form chloramines) to the filtration membrane permeate can increase the risk of accidental chlorine overdose, which can damage the reverse osmosis membrane. Thus, biofouling associated with the use of reverse osmosis of brackish water obtained after biological treatment with conventional ASP or UF/MF MBR increases operating cost and can also lead to more frequent RO membrane replacement, both of which tend to offset any advantages to be had in the use of such brackish water instead of seawater for desalination.

The presently disclosed method of producing potable and non-potable (e.g. process) water from the use of wastewater and seawater streams avoids many of the problems described above.

### Microfiltration (MF) and Ultrafiltration (UF) Membrane Filtration

Microporous membrane filtration may include one or more of the following: microfiltration, and ultrafiltration. In some cases the microporous filtration of wastewater can be performed hydraulically before, after, or in parallel with the forward-osmosis step. In some cases, microporous filtration can be performed in a unit/tank/reactor in which the forward osmosis step is performed. In these embodiments, the microporous filtration is performed in a bioreactor.

Microfiltration and ultrafiltration typically use a porous membrane. In most cases, the feed (active) side contacts the water (source or feed water) to be treated. The permeate (support) side is a porous layer providing mechanical support structure for the membrane. The permeate water is drawn from the permeate side of the membrane as the feed water is passed by the feed side of the membrane. Like reverse osmosis, hydraulic pressure, yet much lower, is applied to induce mass-transfer across the membrane from the feed side to the permeate side. In particular implementations, specific constituents in the feed water are concentrated.

Most suspended contaminants, including most microorganisms, which are larger than the pore size of the membrane, are rejected by microfiltration and ultrafiltration membranes and only water and dissolved components and suspended contaminants smaller than the pore size of the membrane pass through the membrane to the permeate side. A contaminant that is “rejected” is prevented by the membrane from passing through the membrane. Selecting an appropriate membrane usually involves choosing a membrane that exhibits high rejection of suspended solids as well as various organic and/or inorganic compounds while still allowing a high flux (throughput) of water through the membrane at a high or low hydraulic pressure driving force.

Advantages of the microfiltration and ultrafiltration processes may include relatively low operation pressure, low energy consumption, simplicity and reliability, and ability to relatively easily backwash the membrane pores. Because operating hydraulic pressures in the microfiltration and ultrafiltration processes typically are very low (up to a few bars, reflective of the flow resistance exhibited in the flow channels of a membranes module or element and the pressure drop involved in passage of permeate across the membrane), the equipment used for performing the processes may be very simple. Also, use of lower pressure may alleviate potential problems with membrane support in the housing.

Porous filtration membranes, for example microporous filtration membranes, may aid in allowing removal of dissolved solids from a fluid. For example, microporous filtration membranes (microfiltration or ultrafiltration membranes) may aid in preventing passage of some or all suspended solids across the membrane. Where a porous filtration membrane unit is submerged within a liquid in a tank, the porous filtration membrane may aid in allowing passage of water and dissolved solids from the liquid while preventing passage of suspended solids, thus increasing the concentration of suspended solids within the liquid in the tank. A porous filtration membrane, therefore may be used to separate a liquid stream into a first portion with a high concentration of suspended solids, and a second portion with a low concentration of suspended solids, with the dissolved solids concentration being essentially almost the same on both sides (feed and permeate) of the porous membrane. In some cases, a porous filtration membrane may be referred to as a low TDS and high suspended solids removing mechanism. As used herein, “low TDS” refers to low or about 0% removal of TDS. Similarly, “high suspended solids” means high or about 100% removal of total suspended solids. These terms may also be used in reference to semipermeable membranes, for example FO membranes which are a “high TDS” and “high TSS” removing membrane.

Porous filtration membranes for use in the disclosed processes, methods, and systems may be cleaned. In some embodiments, the porous filtration membrane may be cleaned using a mechanism that may include a biphasic fluid flow consisting of a mixture of fluid contents and gas, or a cross flow of the fluid contents across the membrane surface. In some embodiments, the tank containing the porous filtration membrane system may be sealed from the atmosphere and the gas for use in the biphasic fluid flow may be drawn from the headspace of the tank.

The permeate stream from the microporous membrane may be processed by various methods. In some embodiments, the permeate stream is processed by a treatment that may include anaerobic digestion, gasification, pyrolysis, precipitation, and/or crystallization. In some cases, the treated permeate stream may be discharged to waste, treated further before discharge, or recycled or a combination of the aforementioned, with the return stream sent back to the bioreactor or upstream of the bioreactor.

In some cases, the microporous permeate stream may comprise high levels of dissolved nitrogen and phosphorous compounds. In some embodiments, the dissolved nitrogen and phosphorous compounds are ammonia (NH3) and phosphate (PO4). In one embodiment, the microporous permeate stream may be combined with a pressate stream produced by a separator described below.

### Clarification

A clarification step may aid in separating a liquid stream into a portion that comprises more suspended solids than a liquid portion, which may comprise fewer suspended solids. In some embodiments a wastewater may be clarified to separate a mostly liquid portion (clarified liquid) from a suspended solids portion, or sludge (settled sludge). The clarified liquid may be further processed by the hybrid membrane bioreactor and/or by biological nutrient removal. The settled sludge may be further processed in a digester.

### Anaerobic Digester

Waste activated sludge produced by the bioreactor may be further processed. In many embodiments, the waste activated sludge may be directed to a digester, such as an anaerobic digester. In many embodiments, the anaerobic digester may aid in release of phosphorus and nitrogen from the waste activated sludge. After release of phosphorus and nitrogen from the waste activated sludge, the contents of the anaerobic digester may be further processed in a separator.

The separator my separate effluent from the anaerobic digester into a solid portion (a sludge) and a liquid portion (a pressate). In many embodiments, the sludge may be discarded or used in various beneficial processes. In many embodiments, the separator may be a belt thickener.

### Struvite Reactor

Pressate from the separator may be treated to precipitate phosphorus and nitrogen containing compounds. In some embodiments, magnesium oxide (MgO) and magnesium and phosphoric acid (H₃PO₄) may be added to the pressate to precipitate dissolved ammonium and phosphate compounds as struvite (NH₄MgPO₄.6H₂O). In some embodiments, the struvite is precipitated in a struvite reactor to produce struvite precipitate and struvite reactor effluent. In some embodiments, the struvite reactor effluent may be further treated, or polished, by the addition of chemicals to precipitate compounds in the liquid. In some embodiments, after struvite precipitation, the struvite reactor effluent may contain phosphorous and or nitrogen containing compounds that may be precipitated by addition of ferric chloride (FeCl₃) and/or alum [KAl(SO₄)₂.12H₂O].

The permeate stream from the microporous membrane, described above, may be combined with the pressate stream produced by a separator prior to entering the struvite reactor. The struvite reactor may include a specially shaped structure, which is preferably conical in shape. There is a means for addition of the chemical or chemicals for precipitation of ammonia and phosphate as struvite. This chemical is typically a salt of magnesium, preferably Magnesium oxide (MgO), which can provide the source of magnesium in the struvite. Chemicals may also be added to the reactor to adjust the pH of the incoming stream or the incoming stream may be preconditioned to adjust pH prior to entering the reactor by chemical addition or by aeration to strip carbon dioxide. In some cases, a source of phosphorus such as phosphoric acid may also be added to the reactor if the phosphate concentration in the incoming stream is at a lower stoichiometric proportion than what would be required for struvite formation and precipitation. The concentrations of the various chemicals added for struvite formation and for pH adjustment are preferably targeted so as to facilitate the precipitation of struvite by exceeding the saturation concentration or solubility product of struvite. Existing struvite crystals formed in the reactor act as seed crystals that further aid in the formation of more struvite crystals. The reactor is designed and sized to allow formation of struvite crystals of a target size, which settle at the bottom of the reactor and are removed from the bottom while the struvite reactor effluent, which is lean in the ammonia and phosphate compared to the reactor influent, escapes from the top. The fluid velocity within the reactor is chosen so as to allow adequate retention time for the formation of struvite and the precipitation of struvite crystals and to not carry away the formed struvite crystals into the reactor effluent.

Nutrient Recovery and/or Removal

The disclosed process, methods, and systems may include recovery and/or removal of various compounds from wastewater. In some embodiments, a nutrient removal step may be included upstream of the bioreactor and/or downstream of the bioreactor. In various embodiments, the presently disclosed processes, methods, and systems may be used to recover and/or remove organic and inorganic compounds from a wastewater and produce a treated wastewater that is depleted of or has a lowered concentration of certain organic and inorganic compounds and molecules.

Nitrogen, phosphorus, and other compounds may be removed from wastewater in various ways. The disclosed processes, methods, and systems may include an aerobic reactor. In some embodiments, the aerobic reactor may oxidize organic carbon and hydrogen without oxidizing nitrogen, thus removing only the carbonaceous oxygen demand (cBOD). In some embodiments, the aerobic reactor may oxidize carbon and hydrogen and oxidize nitrogen by nitrification and remove nitrogen as nitrogen gas by denitrification in an anoxic step without an anaerobic step required to remove phosphorus. In some embodiments, the aerobic reactor may oxidize carbon and hydrogen and oxidize nitrogen by nitrification and remove nitrogen as nitrogen gas by denitrification in an anoxic step and include an anaerobic step required to remove phosphorus. In various embodiments, the aerobic reactor may oxidize organic carbon, hydrogen, and nitrogen. In some embodiments, the aerobic reactor may be used in nitrification. The disclosed processes, methods, and systems may include an anoxic reactor that may be used in denitrification.

Biological nitrogen removal may be accomplished by nitrification and denitrification. De-nitrification may be done under anaerobic conditions, such as in an anoxic reactor by denitrifying bacteria from various genera (for example pseudomonas, alkaligenes and bacillus). In the anoxic reactor, nitrates are converted to nitrogen gas (N₂(g)), which may be removed or recovered from the system by venting or capturing the nitrogen gas.

Nitrification involves a process that converts nitrogen containing compounds (e.g. ammonium, NH₄⁺, and ammonia, NH₃) to nitrates (i.e. NO₃⁻ compounds). This is usually a two-step process accomplished by ammonium oxidizing bacteria, or AOB (e.g. Nitrosomonas, Nitrosospira, Nitrosococcus, Nitrosolobus, etc.), and nitrite-oxidizing bacteria (NOB) (e.g. Nitrobacter, Nitrospina, Nitrococcus, etc.). In the first step, ammonium is oxidized to nitrite by ammonium oxidizing bacteria. The second step involves the oxidation of the nitrite NO₂⁻ to form nitrate. In some cases, this conversion may occur in an aerobic reactor. In some cases, nitrification may be followed by or preceded by de-nitrification (the terms followed by or preceded are meant in the sense of a hydraulic flow arrangement and not in a temporal sense), which converts nitrates to N₂ gas.

Phosphorus may also be removed or recovered in various ways. In one example, phosphorus removal may be aided by the use of phosphate-accumulating organisms (PAOs). In some cases, phosphate-accumulating organisms may be capable of storing orthophosphate, that is salts and esters of othophosphoric acid, H₃PO₄. Accumulation of orthophosphates by these organisms may be in excess of their biological growth requirements. In many cases, the process occurs in an anaerobic environment, for example an anaerobic reactor, and a supply of organic matter (for example, volatile fatty acids) that may be metabolized by the PAOs. In these cases, the PAOs may break down stored polyphosphates and release phosphorus. Energy from this reaction may be used to produce compounds called PHAs (polyhydroxyalkanoates), which may act to store the energy released from polyphosphate metabolism.

In the presence of oxygen, the PAOs may use the energy stored in the PHAs to take up the phosphorus compounds created under anaerobic conditions as well as any other available phosphates present to create new polyphosphate compounds. Thus, the polyphosphate pool may be renewed under aerobic conditions, such as in an aerobic reactor. If the polyphosphates remain with the PAOs these compounds may be mixed with a sludge portion of the waste stream. The sludge, containing the polyphosphates, may then be returned to the anaerobic conditions, and the anaerobic step repeated. In some cases, the phosphorus taken up by the sludge can be released during digestion of the waste activated sludge (WAS) in the anaerobic digester. Anaerobic digestion releases phosphorus and nitrogen into the liquid phase. This liquid phase, rich in nitrogen and phosphorus compounds, may be referred to as a side-stream. The side-stream can be separated from the sludge with a suitable method such as belt thickening.

Phosphorus compounds may also be removed chemically. In some embodiments, ferric chloride or alum can be used to precipitate phosphorus. In some cases, these chemical precipitation processes may be used in combination with biological processes as backup or standby systems to help reduce the phosphorus levels achieved by biological means.

The disclosed processes, methods, and systems may avoid drawbacks of traditional recovery/removal techniques. In some cases, nitrogen and phosphorus recovery methods may require expenditure for capital costs associated with the anoxic tank, recirculation pumps, piping, and mixers, as well as operating costs associated with energy for aeration, recirculation, and mixing. In addition there are costs associated with chemicals (nitrogen recovery requires chemicals to regulate the pH and add electron donor such as methanol to the anoxic tank, and phosphorus recovery requires carbon source such as volatile fatty acids to be added to the anaerobic tank as well as ferric or alum addition to precipitate phosphorus not removed by the biological phosphorus removal method). Finally, various nitrogen recovery methods require additional costs in order to mitigate process upsets (such as loss of bacteria due to changes in pH, temperature, or the presence of inhibitors, all of which may upset or slowdown the rate of nitrification and efficiency), and phosphorus removal requires disposal of the sludge consisting of phosphorus precipitated with ferric chloride and/or alum.

### Commercial Application

The disclosed processes, methods, and systems can be used to upgrade to an existing wastewater treatment process that uses BNR (with or without MBR) for N and P removal to improve the efficiency of N or P removal. In some embodiments, the wastewater treatment system would use a readily available source of draw solution (e.g. seawater for a coastal location or RO concentrate from a process RO). This would reduce the cost associated with RO or another draw solution recovery process.

The disclosed processes may also be used to upgrade existing systems in order to increase their treatment capacity. In some cases, anaerobic and anoxic tanks can be modified for use as aerobic tanks, thus increasing the treatment capacity of the treatment plant in terms of organic/nutrient loading and/or influent flow.

The disclosed processes, methods, and systems can also be added to new wastewater treatment plants or existing wastewater plants that do not have BNR.

The disclosed processes, methods, and systems can also be used in coastal wastewater treatment facilities for small coastal communities or municipalities, coastal apartment complexes or resorts, utilities for coastal towns or cities, or turnkey installations to treat multimillion gallons per day of wastewater or produce multimillion gallons per day of potable/process from seawater. The coastal facilities could also include coastal industrial plants or refineries or other similar operation which use SWRO to produce process water.

The disclosed processes, methods, and systems can also be used in cruise ships, marine military vessels, and other marine environments that require treatment of water. Use of the disclosed system in these environments may help lower energy costs (and lower fuel consumption), increase productivity for a given SWRO system size, or a combination thereof.

The disclosed processes, methods, and systems can also be used to reduce the amount of antiscalants used in a given system, and in the case of marine vessels, reduce the amount of antiscalant that needs to be carried on board the marine vessel.

The disclosed processes, methods, and systems can also be used to reduce the footprint of a vessel's SWRO system.

### EXAMPLES

### Example 1

### OMBR System

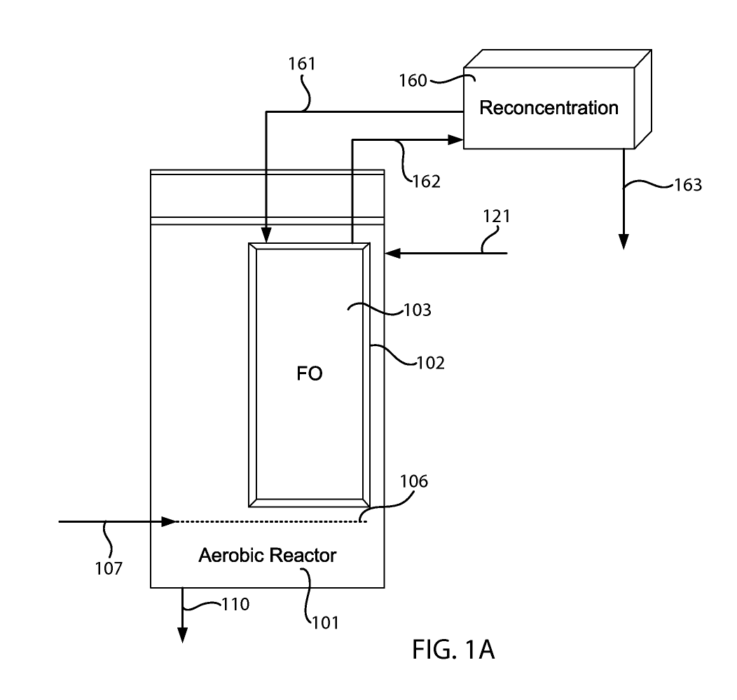

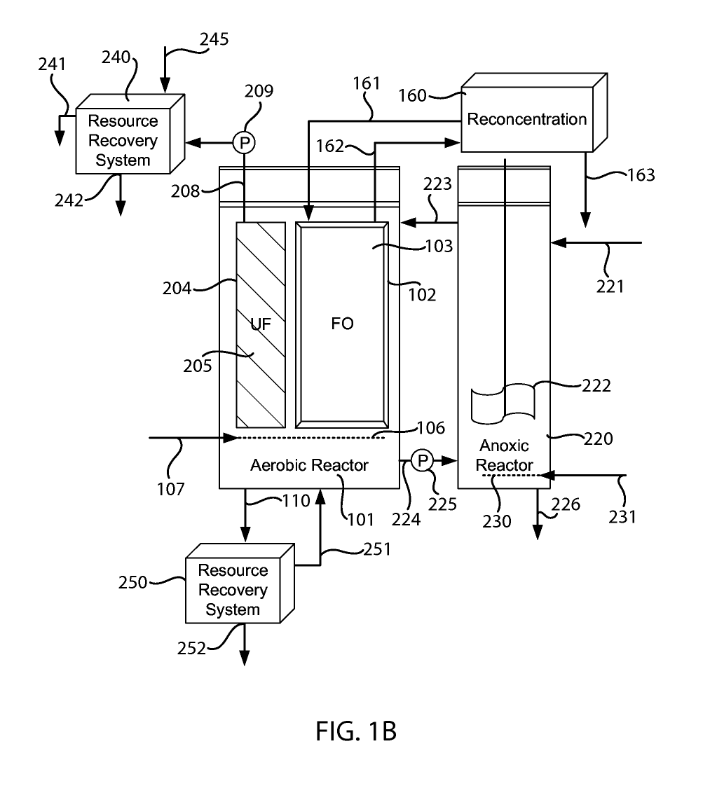

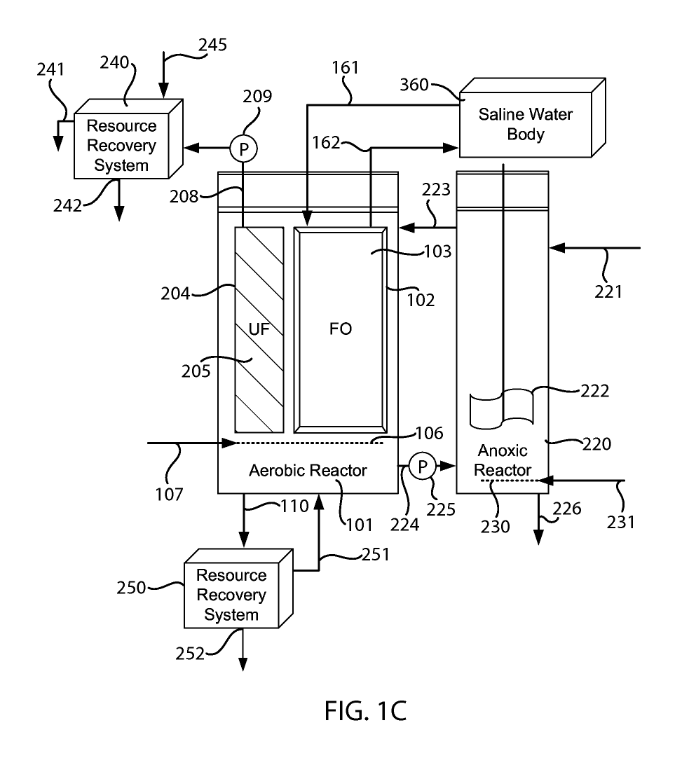

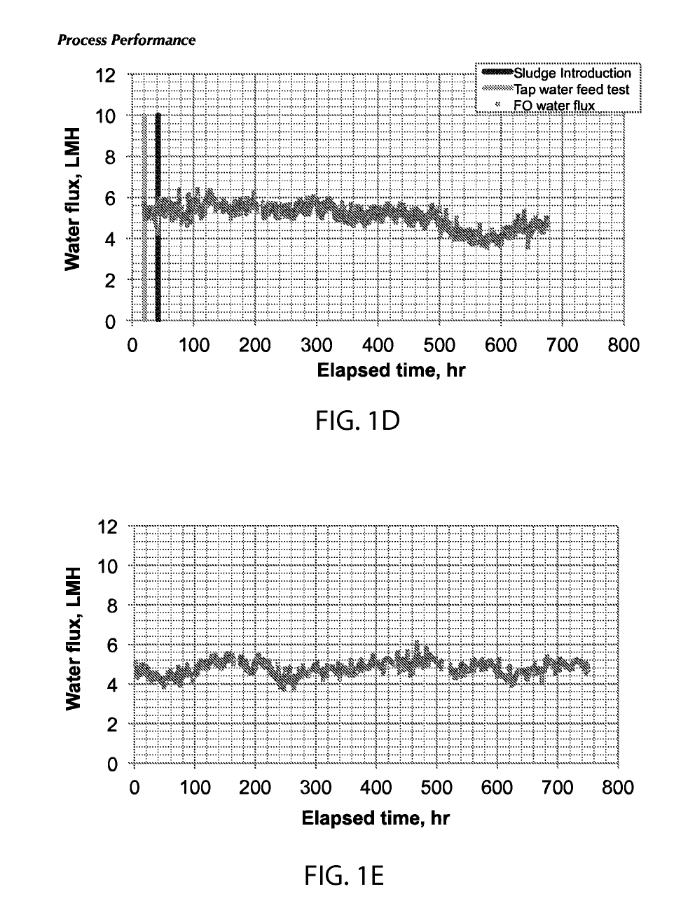

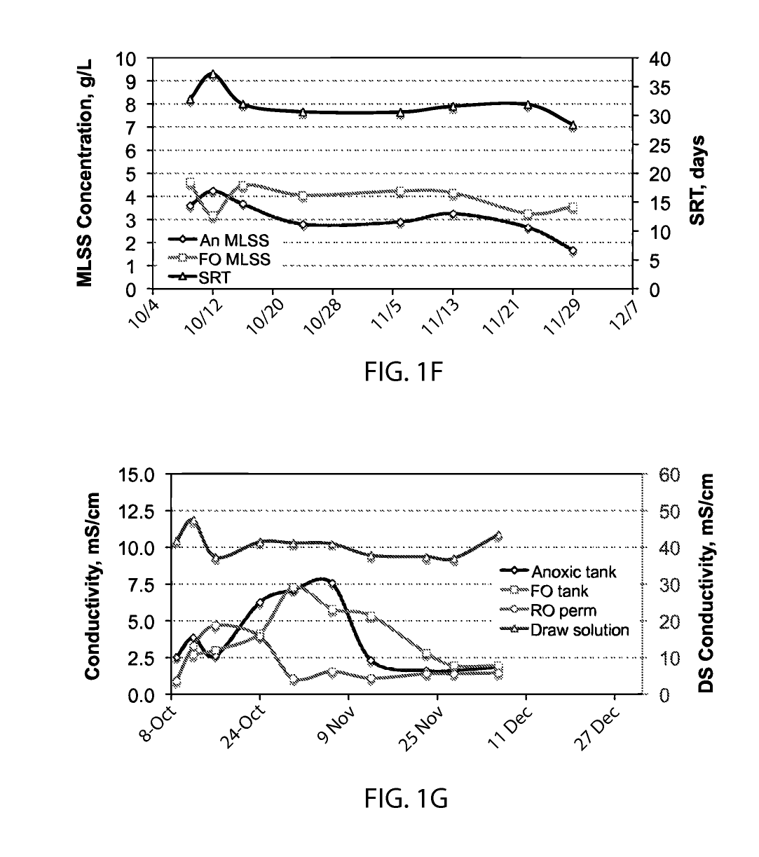

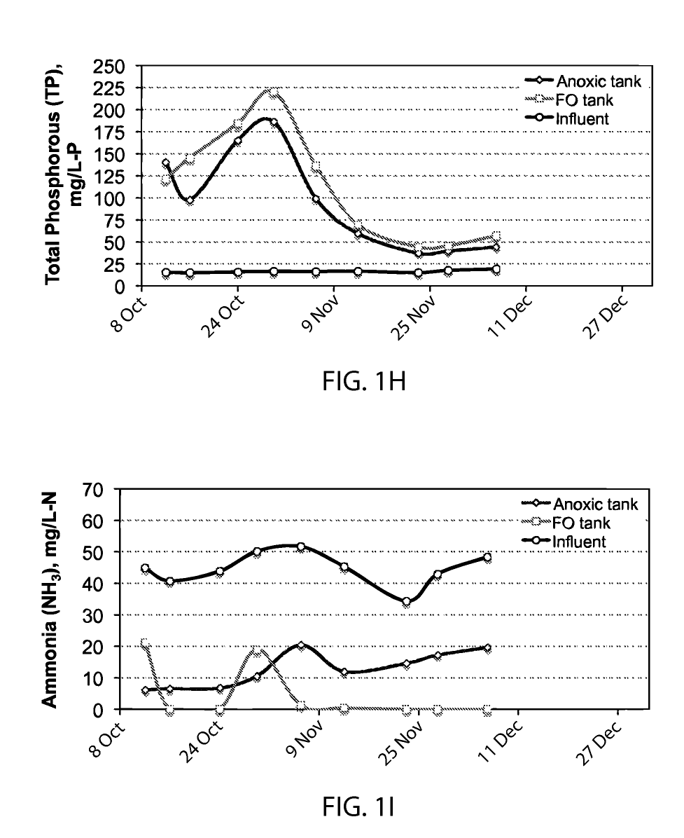

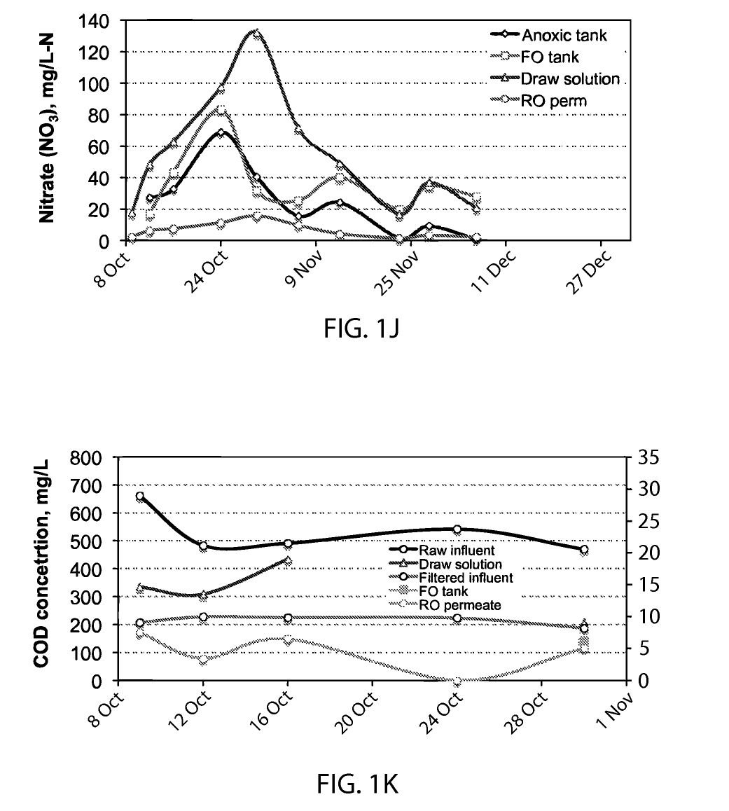

An exemplary apparatus for use in OMBR aspect of the current disclosure is illustrated in FIG. 1A to clarify and illustrate the advantages of the proposed tailored process. In such an apparatus, a forward osmosis membrane device 102 or plurality of devices, having osmosis membrane 103 installed on one or more surfaces, is submerged in a reactor or bioreactor 101. Reactor 101 might contain activated sludge, or raw wastewater, or microalgae suspension. Although generally described in these exemplary systems for use in treatment of municipal wastewater, the methods and systems described in the exemplary embodiments may be applied to other source liquids that may serve as feed stream to be treated in the reactor. Compressed air 107 is supplied to an air diffuser 106 or, plurality of diffusers installed under the membrane devices to promote scouring at the membrane surface and prevent membrane fouling. In most circumstances the air also induces mixing in the reactor. In particular circumstances the air also promotes and accomplishes oxidation of specific constituents in the reactor. Raw source feed water 121 flows into reactor 101 under controlled conditions, helping to maintain i) an appropriate feed volume, ii) the membrane devices 102 fully submerged, and iii) the reactor 101 level to avoid overflowing. Waste stream 110 is drawn intermittently or continuously to maintain predetermined concentration of specific constituents in the reactor 101.

Draw solution having high osmotic pressure is used to withdraw water from the reactor 101 through the osmosis membranes 103. Concentrated draw solution 161 from a reconcentration process flows into the osmosis membrane device 102. The concentrated draw solution 161 flows in particular fashion inside the membrane device 102, absorbing water and becomes diluted, and leaves the membrane device as a diluted brine 162 back into the reconcentration element or system 160 for processing. The reconcentration element or system 160 uses chemical or physical processes, or a combination of them, to reconcentrate the diluted draw solution 162 into a reusable draw solution 161, and produces a product stream 163. The reconcentration process occurring in the reconcentration element or system 160 may include reverse osmosis, nanofiltration, thermal distillation, membrane distillation, electrodialysis, evaporation pond, or any chemical or physical process that may separate the solute from the solvent in the draw solution 162, or many combinations of these reconcentration processes.

Because osmosis membranes and processes generally exhibit a low degree of fouling and scaling, forward osmosis may be advantageously used in this example in FIG. 1 for drawing water from almost any source water or impaired water for use in most downstream processes. This may eliminate multiple other treatment steps as well as protect the reconcentration/water purification process 160 from organic and inorganic foulants.

While the osmotic membrane bioreactor system as shown in FIG. 1 is efficient and may produce water of very high quality (163), there are shortcomings that might limit the performance of the process illustrated in FIG. 1A. These include the accumulation of constituents that enter reactor 101 with the raw source water stream 121 or constituents that formed in the reactor, both of which cannot leave the system through the tight osmosis membrane 103, but only through the waste stream 110. These constituents commonly increase the osmotic pressure of the source water and therefore reduce the driving force for water flux through the forward-osmosis membrane. These accumulated constituents may also reduce the biological activity in the reactor. Additionally, constituents may accumulate in reactor 101 that transport relatively easily through the forward-osmosis membrane 103 and are not desirable in the draw solution streams 161 and 162, or in the reconcentration process 160. There is also a lack of means to recover specific constituents that might accumulate in reactor 101. Finally, only one product stream is produced that may serve for limited number of applications.

A more robust and flexible osmotic membrane bioreactor is presented in FIGS. 1B and 1C to enable more diverse reuse of reclaimed water.

FIG. 1B shows a flexible tailored water-treatment system made up of components that perform a process as described below. A system is depicted in FIG. 1B, which is similar to the system in FIG. 1A in many respects. Components of the system 200 shown in FIG. 1B that are the same as respective components of the system 100 shown in FIG. 1A have the same respective reference designators and are not described further except as noted below.

The system 200 of FIG. 1B includes an anoxic reactor 220, anoxic reactor mixer 222, source feed water 221, aerobic source stream 224 and return anaerobic stream 223, recirculation pump 225, low-pressure membrane filtration unit 204 comprised of low-pressure porous membranes 205, low-pressure permeate line 208, permeate vacuum-pressure pump 209, resource recovery system 240 with chemical addition 245, recovered resource stream 242, resource recovery product stream 241, and material and energy resource recovery system 250.

In FIG. 1B the source water 221 is supplied to the anoxic tank 220 and mixed with anoxic reactor mixer 222. The recirculation pump 225 draws liquid from the aerobic reactor 101 and transfers it into the anoxic reactor 220. Anoxic liquid 223 from the anoxic reactor 220 returns through a conduit back into the aerobic reactor 101. Liquid from the anoxic reactor 220 may be wasted intermittently or continuously through line 226 in order to control the concentrations of specific constituents in the reactor.

The anoxic reactor 220 might have one or a plurality of compartments and it might also include an air diffuser 230 installed at the bottom of the reactor to supply air 231 to achieve oxidation of specific constituents and/or mixing in specific regions of the anoxic reactor 220.

By combining the input of the raw source water 221 into the reactor 220, extracting waste from the reactor 220 through line 226, and controlling the mixing and oxygen concentration in the anoxic reactor 220, specific constituents such as nitrogen and phosphorous, or others, may be removed from the system.

In specific embodiments, a second membrane device 204 is located and operated in parallel to the osmosis membrane device 102 in the aerobic reactor 101. Membrane device 204 comprises low-pressure porous membranes 205, which may be ultrafiltration or microfiltration membranes. The source water in the aerobic reactor 101 is drawn continuously or intermittently by the permeate pump 209 through the low-pressure membrane 205. Source water filtered by the low-pressure membrane 205 is directed through conduit 208 to the resource recovery system 240.

Resources such as phosphorus, nitrogen, and other recoverable resources that permeate through the low-pressure membrane 205 are recovered in the resource recovery system 240 using chemical precipitation or other means such as ion exchange resins. Recovered resources are removed from the resource recovery system 240 through the recovered resource stream 242. Chemical or other resource recovery additives may be added to the resource recovery system 240 through chemical addition 245. Treated water is recovered from the resource recovery system through the resource recovery product stream 241. Additional water may be recovered in the resource recovery system with the addition of reverse osmosis or nanofiltration membranes.

In some implementations, reactor 101 might be sealed from the atmosphere and the gas 107 (when drawn from headspace, the gas is a gas like biogas and not air) for the diffuser 106 is drawn from the headspace of the reactor 101. Under this condition the reactor is operated in anaerobic MBR mode and may enable the recovery of biogas for energy production.

The waste stream 110 is directed into a resource/energy recovery system 250. The resource/energy recovery system 250 could include one or plurality of resource or energy recovery devices such as anaerobic digestion, gasification, pyrolysis, or other energy or resource recovery technologies.

The disclosed systems and methods may provide a number of benefits. Because low-pressure membrane processes such as microfiltration and ultrafiltration allow dissolved solids and dissolved constituents (e.g., minerals, nutrients (nitrogen and phosphorus), low molecular weight organic compounds) to pass through the membrane, the dissolved solids, which are detrimental to biological activity and the forward osmosis process may be removed from the aerobic reactor and the dissolved constituents may be recovered in the resource recovery system. Thus, the hybrid system may produce water of different qualities for various applications ranging from irrigation and toilet flushing with water from the low pressure membranes through livestock watering and potable reuse of reclaimed water through the forward osmosis membranes followed by the reconcentration process.

FIG. 1C shows another example of the flexible water-treatment process. Components of system 300 shown in FIG. 1C that are the same as respective components of the system 100 shown in FIG. 1A, or system 200 shown in FIG. 1B have the same respective reference designators and are not described further except as noted below. The system of FIG. 1C is described in conjunction with components of the system of FIG. 1B, but could be used in other systems, including the system of FIG. 1A.

The system 300 of FIG. 1C does not include a reconcentration system to reconcentrate the draw solution and produce high quality product water 163. Instead, the draw solution is taken from a natural or human made saline water body 360. The concentrated draw solution from the water body 360 enters the forward osmosis device 102 through conduit 161 and the diluted draw solution is returned to the saline water body 360 through conduit 162.

The system in FIG. 1C might beneficially serve dilution with highly treated water needed in reservoir 360.

Testing has been performed with an embodiment of the disclosed system. Results from these tests are depicted in FIGS. 1D-1K. The tested system included an aerobic reactor and an anoxic reactor similar to the embodiments depicted in FIGS. 1B and 1C. The tested system included an air scouring system, for aiding in keeping air scouring close to the membranes, a draw solution flow meter for each membrane plate, a total suspended solids (TSS) probe and a dissolved oxygen (DO) probe, a peristaltic pump, to aid in removing wastes sludge, a constant level switch in the anoxic bioreactor, and, as shown in FIG. 1B, an ultra filtration membrane installed with the forward osmosis membrane in the aerobic tank. This system was tested by continuous operation for over 2,000 hours. FIGS. 1D and 1E show water flux as a function of time for the first and second month, respectively, of operation, wherein the draw solution concentration was constant throughout the first month of operation at about 32 g/L NaCl. FIG. 1F through K are graphs of various aspects of water quality analysis during the test period. FIG. 1F depicts mixed liquor suspended solids (MLSS, in g/L) and solids retention time (SRT, in days) vs. time in days. FIG. 1G depicts conductivity (in mS/cm) and DS conductivity (in mS/cm) vs. time in days. FIG. 1H depicts total phosphorous (TP, in mg/L-P) vs. time in days. FIG. 1I depicts Ammonia (NH₃, in mg/L-N) concentration vs. time in days. FIG. 1J depicts Nitrate (NO₃, in mg/L-N) concentration vs. time in days. FIG. 1K depicts chemical oxygen demand (COD, in mg/L) vs. time in days.

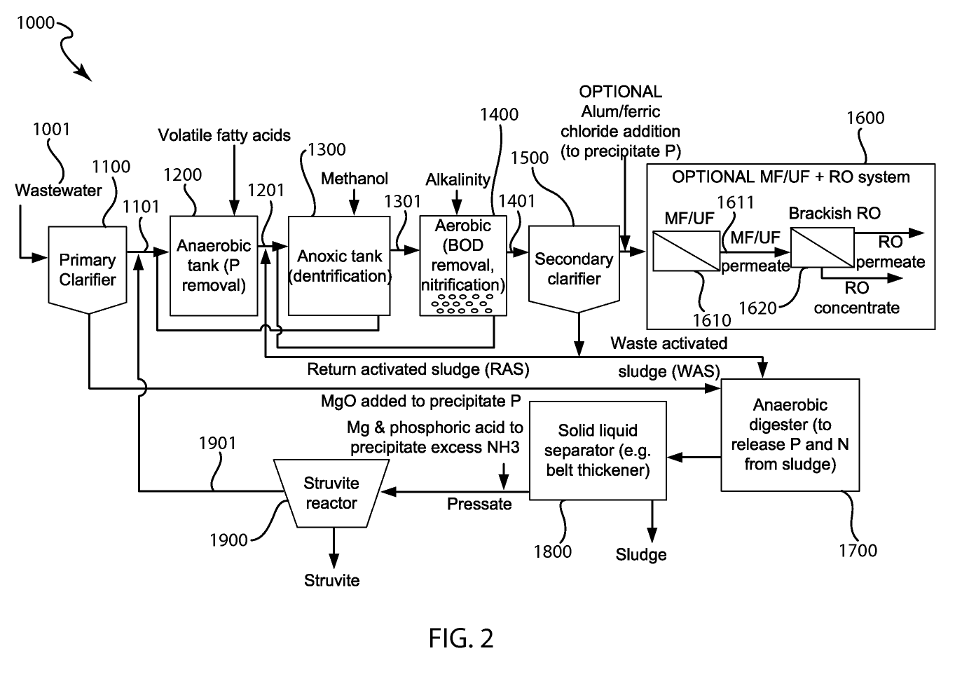

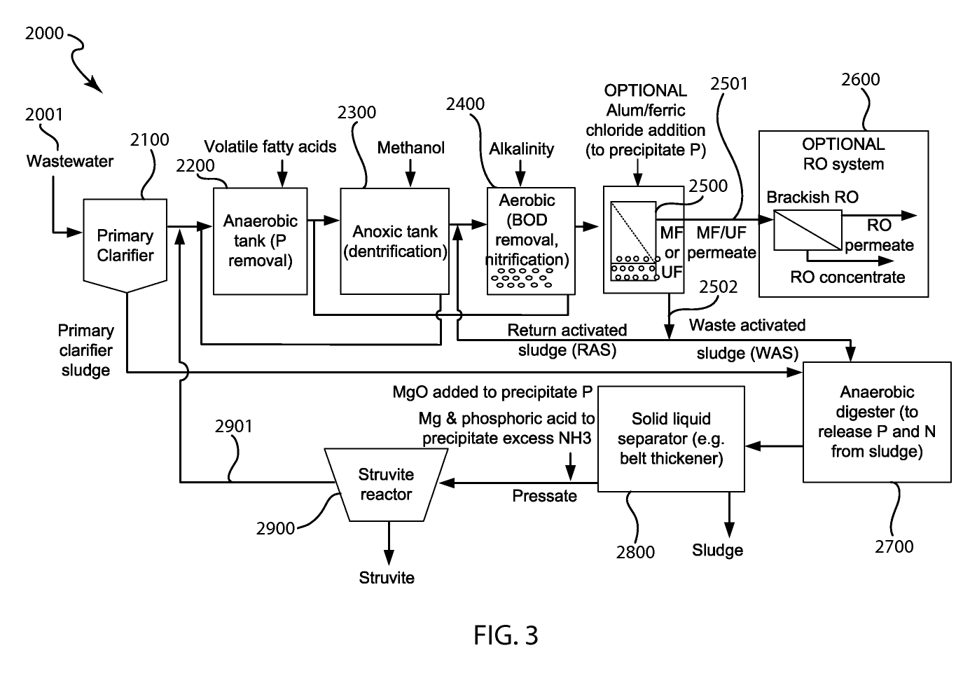

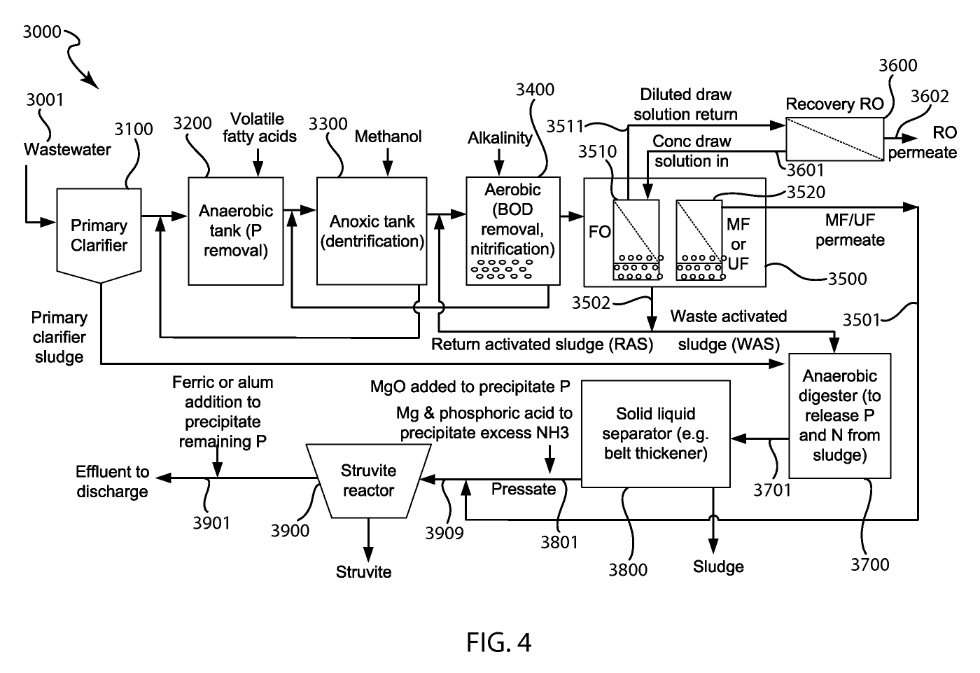

Table 1 summarizes systems presented in FIGS. 2 and 3 followed by summaries of some of the presently disclosed configurations in FIGS. 4 through 9.

TABLE 1
Summary of Disclosed Processes, Methods and Systems

| | | Bioreactor | | | | | Draw | |
|---|---|---|---|---|---|---|---|---|
| | | separation | Nitrogen | Phosphorus | Nutrient | Draw | solution | Optional |
| | Description | process | removal | removal | recovery | solution | recovery | Process |
| FIG. 2 | WWTP + | Conventional | Nitrification + | Anaerobic | Recover struvite | Not | Not | RO treatment of MF |
| | Clarifier + | WWTP with | denitrification | (biological) + | from waste | applicable | applicable | permeate |
| | struvite | clarifier | (anoxic) | Chemical | activated sludge | | | |
| | reactor | | | (optional) | | | | |
| FIG. 3 | MF/UF MBR + | MF/UF MBR | Nitrification + | Anaerobic | Recover struvite | Not | Not | MF treatment of |
| | struvite | | dentrification | (biological) + | from waste | applicable | applicable | clarifier effuent |
| | reactor | | (anoxic) | Chemical | activated sludge | | | followed by RO |
| | | | | (optional) | | | | treatment of UF |
| | | | | | | | | permeate |

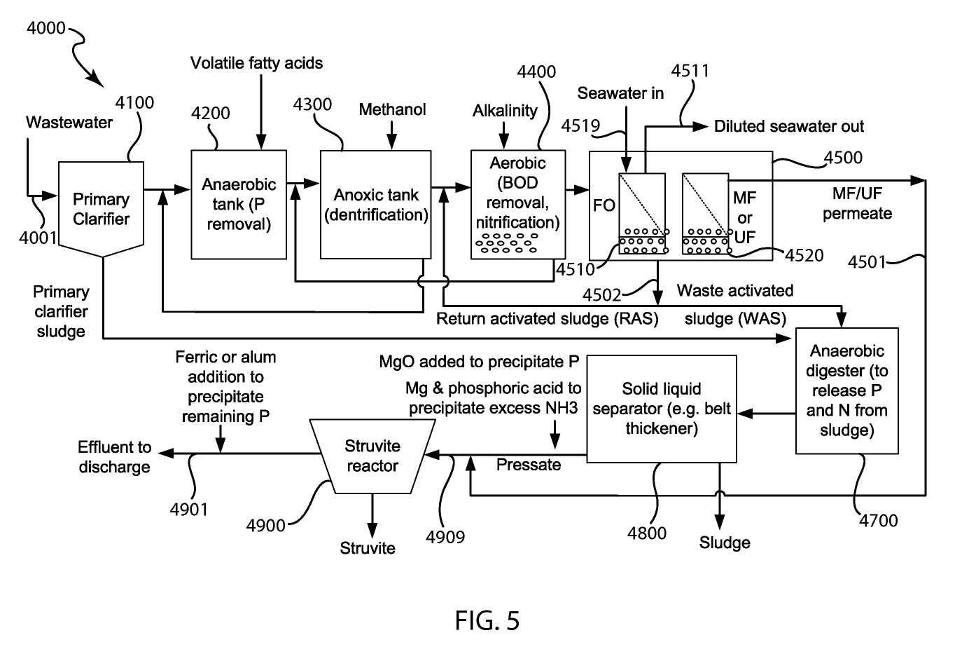

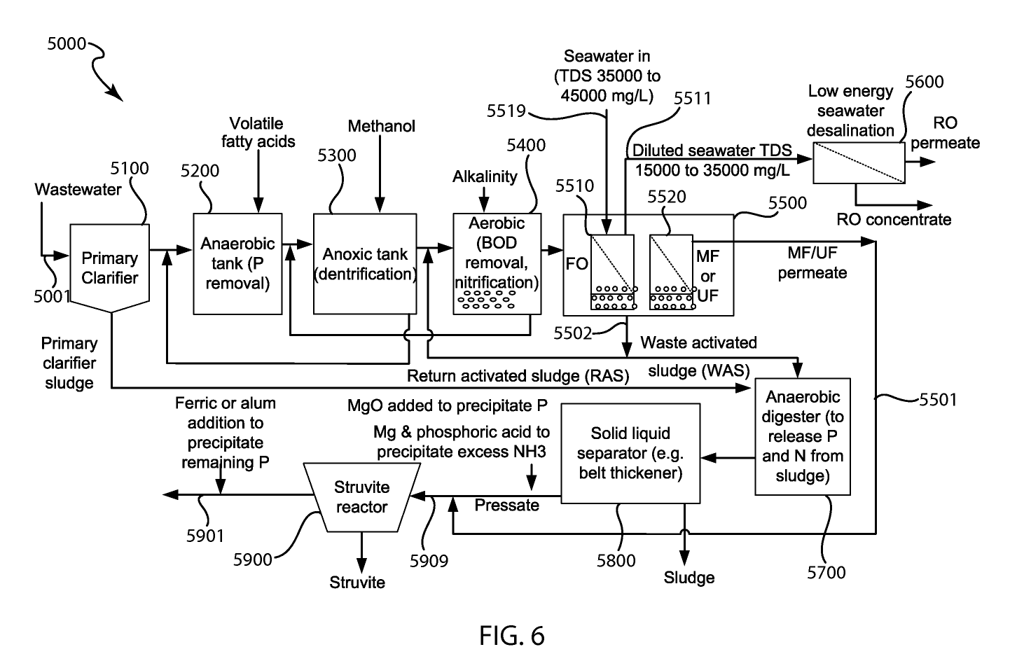

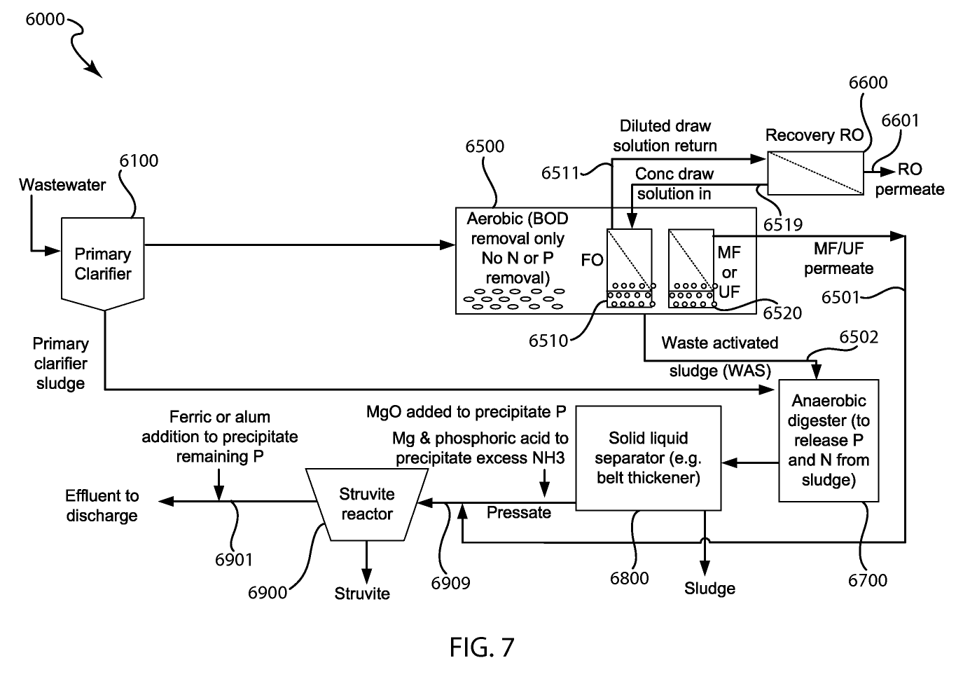

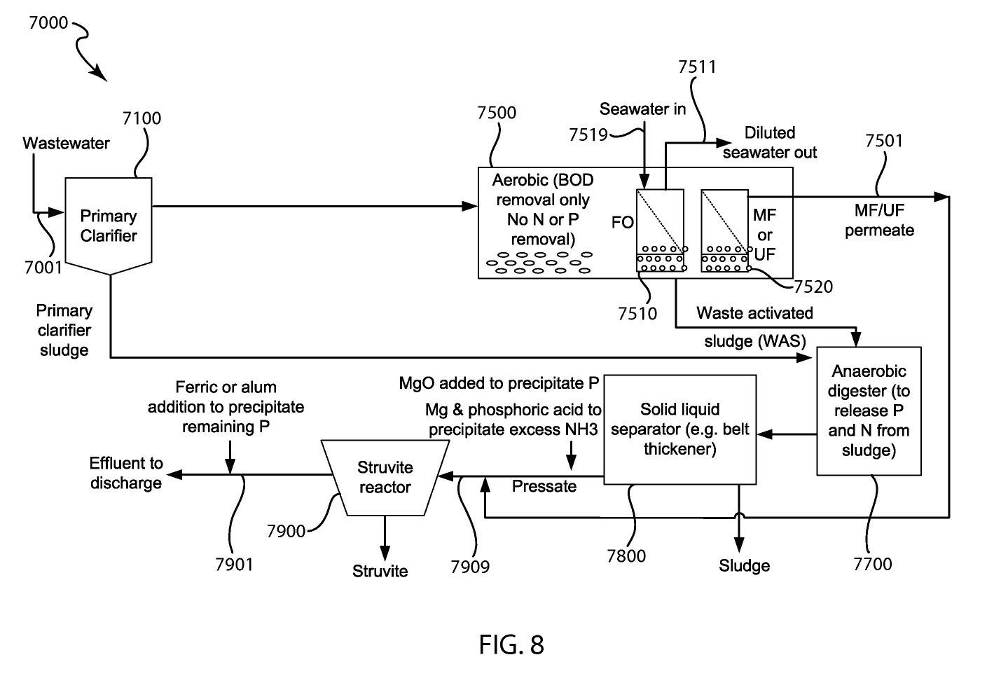

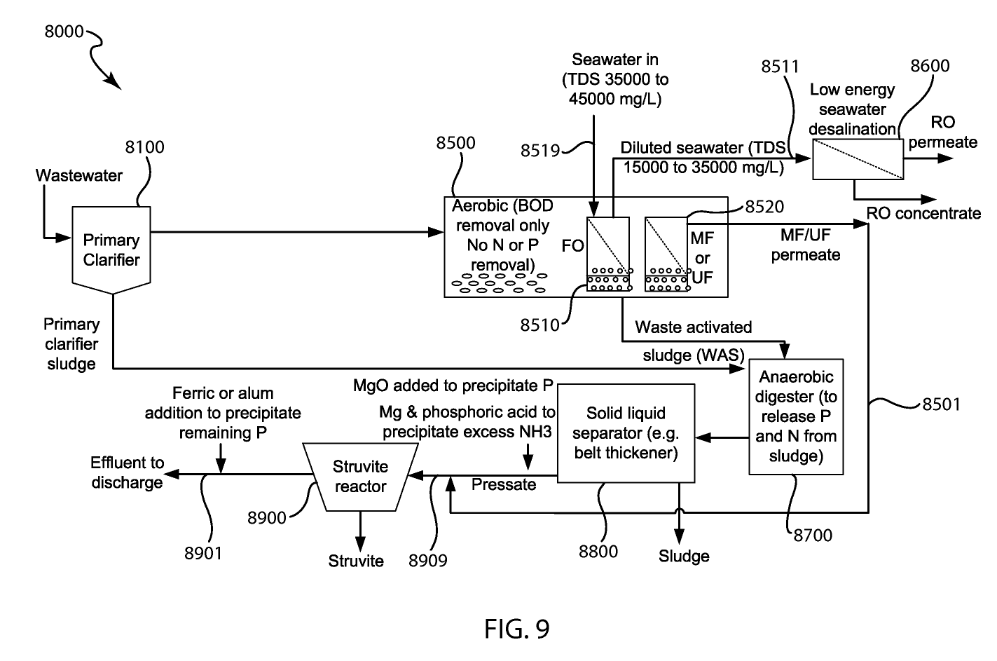

EXEMPLARY CONFIGURATIONS

| | | | | | | | |
|---|---|---|---|---|---|---|---|
| FIG. 4 | Hybrid MBR + | Hybrid FO + | Nitrification + | Anaerobic | Recover struvite | Made of | Reverse |
| | BNR + | MF/UF MBR | dentrification | (biological) + | from waste | suitable draw | Osmosis with |
| | Recovery RO + | | (anoxic) + FO | FO | activated sludge | solute such | suitable draw |
| | struvite | | membranes | membranes | AND MF | as sodium | solute such as |
| | reactor | | | | permeate | chloride | sodium chloride |
| FIG. 5 | Hybrid MBR + | Hybrid FO + | Nitrification + | Anaerobic | Recover struvite | Seawater, | Seawater as |
| | BNR + | MF/UF MBR | dentrification | (biological) + | from waste | Concentrate | draw solution |
| | Seawater | | (anoxic) + FO | FO | activated sludge | from process | (no recovery) |
| | draw + struvite | | membranes | membranes | AND MF | RO | |
| | reactor | | | | permeate | | |
| FIG. 6 | Hybrid MBR + | Hybrid FO + | Nitrification + | Anaerobic | Recover struvite | Seawater, | Seawater as |
| (No | BNR + | MF/UF MBR | dentrification | (biological) + | from waste | Concentrate | draw solution |
| BNR) | Seawater | | (anoxic) + FO | FO | activated sludge | from process | followed by |
| | draw + Deaal | | membranes | membranes | AND MF | RO | desalination of |
| | RO + struvite | | | | permeate | | diluted seawater |
| | reactor | | | | | | |
| FIG. 7 | Hybrid MBR + | Hybrid FO + | FO membranes | FO membranes | Recover struvite | Made of | Reverse |
| (No | Recovery | MF/UF MBR | (No nitrification | (No anaerobic | from waste | suitable draw | Osmosis with |
| BNR | RO + struvite | | and | treatment) | activated sludge | solute such | suitable draw |
| | reactor | | denitrification) | | AND MF | as sodium | solute such as |
| | | | | | permeate | chloride | sodium chloride |
| FIG. 8 | Hybrid MBR + | Hybrid FO + | FO membranes | FO membranes | Recover struvite | Seawater, | Seawater as |
| (NO | Seawater | MG/UF MBR | (No nitrification | (No anaerobic | from waste | Concentrate | draw solution |
| BNR) | draw + struvite | | and | treament) | activated sludge | from process | (no recovery) |
| | reactor | | denitrification) | | AND MF | RO | |
| | | | | | permeate | | |
| FIG. 9 | Hybrid MBR + | Hybrid FO + | FO membranes | FO membranes | Recover struvite | Seawater, | Seawater as |
| (NO | Seawater | MF/UF MBR | (No nitrification | (No anaerobic | from waste | Concentrate | draw solution |
| BNR) | draw + Deaal | | and | treament) | activated sludge | from process | followed by |
| | RO + struvite | | denitrification) | | AND MF | RO | desalination of |
| | reactor | | | | permeate | | diluted seawater |

### Example 2

### Comparative System 1

FIG. 2 is an example of a conventional BNR system 1000 with phosphorus as well as nitrogen removal. There can be variations of the configuration where the process only incorporates either nitrogen (N) or phosphorous (P) removal but not necessarily both N and P removal (as shown above). A clarifier 1100 is used to settle and separate the sludge and recirculate it. Other BNR recirculation schemes can also be used. Chemicals may be added to the clarifier effluent for final polishing so as to remove additional dissolved P. If process or potable water is required, microfiltration/ultrafiltration porous membrane (MF/UF) system 1610 is used to remove any remaining suspended solids and the MF/UF permeate 1611 is then sent to a brackish RO system 1620 to remove dissolved solids. As explained above, the dissolved nutrients in the MF/UF permeate can cause fouling of the RO membranes. Chlorine is usually added to the MF/UF permeate to form chloramines after reacting with residual ammonia. The chloramines help in controlling biofouling of the RO membranes but the chlorine addition can potentially lead to RO membrane damage in case of an accidental chlorine overdose.

A struvite reactor 1900 is installed in the side-stream to precipitate and remove P and N as struvite (magnesium ammonium phosphate). The supernatant from the struvite reactor 1901 is sent back to the front of the plant. The struvite reactor 1900 helps in removing the P, and to some extent, the N load going back to the front of the plant.

### Example 3

### Comparative System 2

FIG. 3 is an example of a BNR system 2000 that uses MF/UF membrane bioreactor 2500 for solids separation (instead of a clarifier 1500 as shown in FIG. 2). There can be variations of the above configuration where the process only incorporates either N or P removal but not necessarily both N and P removal (as shown above). The scheme of recirculation (shown above) between the various tanks is what could be typically used but other BNR recirculation schemes are also possible. Chemicals may be added to the system for final polishing so as to precipitate any additional dissolved P which would then be separated by the membranes. If process or potable water is required, MF/UF permeate 2501 is sent to a brackish RO system 2600 to remove dissolved solids. As explained earlier, the dissolved nutrients in the MF/UF permeate 2501 can cause fouling of the RO membranes. Chlorine is usually added to the MF/UF permeate 2501 to form chloramines after reacting with residual ammonia. The chloramines help in controlling biofouling of the RO membranes but the chlorine addition can potentially lead to RO membrane damage in case of an accidental chlorine overdose.

A struvite reactor 2900 is installed in the side-stream to precipitate and remove P and N as struvite (magnesium ammonium phosphate). The supernatant 2901 from the struvite reactor 1900 is sent back to the front of the plant. The struvite reactor helps in removing the P, and to some extent, the N load going back to the front of the plant.

### Example 4

FIG. 4 shows one configuration of the disclosed process/system which 3000 uses BNR system 1000 coupled with a hybrid MBR 3500 with osmotic (semipermeable) membranes as well as porous (MF or UF) membranes. It does not have any chemical addition to remove P in the main treatment process.

A recovery RO 3600 is used to concentrate the draw solution 3511. There can be variations of the above configuration where the process only incorporates either N or P removal but not necessarily both N and P removal (as shown above). The scheme of recirculation (shown above) between the various tanks is what could be typically used but other BNR recirculation schemes are also possible. The FO (forward osmosis) membranes 3510 reject suspended solids and a majority of the dissolved solids in the system and water is pulled across the FO membranes by the concentrated draw solution 3601 on the other side of the membranes. The draw solution 3601 gets diluted by the water coming across the FO membranes and is sent to the RO system 3600 for concentration so it can again be returned to the FO membranes. The RO system 3600 produces permeate 3602 which is filtered across two semipermeable membranes (FO and RO) and may comprise very low dissolved solids (depending on the choice of draw solute(s) and rejection of the RO membranes used) and thus can be used for process applications. Alternately, the RO permeate 3602 can be treated further as required by suitable methods such as UV and/or ozone to obtain potable quality water. Compared to the configuration in FIGS. 2 and 3 where the final treated water goes through a porous (MF or UF) followed by a semipermable (RO) membrane, the final treated water in the above configuration goes through two semipermeable membranes (FO and RO). Hence, the concentration of compounds such as endocrine disrupting chemicals (EDCs) may be significantly lower in the RO permeate from the hybrid MBR shown above.

The concentration of dissolved N and P in the configuration in FIG. 4 may be higher compared to the configurations shown in FIGS. 2 and 3. This is because the FO membranes reject N and P, which accumulate in the system. This higher concentration of N and P goes to the struvite reactor 3900 through the MF/UF permeate 3501 and also through the waste activated sludge (WAS) 3502 (after anaerobic digestion 3700 and a process such as belt thickening 3800). The high concentration of N and P in the struvite reactor influent 3909 can improve the yield and kinetics of the struvite reactor 3900. Moreover, since the majority of the struvite reactor influent 3909 comes in filtered through the MF/UF membranes, the final fertilizer product has much higher purity (low suspended impurities) compared to the configurations presented in FIGS. 2 and 3. Ferric chloride or alum may be added to the effluent 4901 from the struvite reactor 4900 to remove or reduce the concentration of dissolved P not removed by the struvite reactor. Zeolite ion exchange systems may be used to remove ammonia from the struvite reactor effluent. The zeolite used in the ion-exchange systems may be clinoptiloite. In some embodiments ammonia in the struvite reactor effluent may be removed by converting to nitrogen gas using the Anammox process.

### Example 5

FIG. 5 shows a configuration of the disclosed process/system 4000 which uses BNR system 1000 coupled with a hybrid MBR 4500 with osmotic (semipermeable) membranes 4510 as well as porous (MF or UF) membranes 4520. It does not have any chemical addition to remove P in the main treatment process.

Seawater is used as draw solution 4519. There can be variations of the above configuration where the process only incorporates either N or P removal but not necessarily both N and P removal (as shown above). The scheme of recirculation (shown above) between the various tanks is what could be typically used but other BNR recirculation schemes are also possible.

In this configuration, seawater serves as the draw solution 4519 and gets diluted by the water coming across the FO membranes 4510. The diluted seawater 4511 is then discharged back to the ocean or marine body.

Even though treated water is not available in this configuration (since diluted seawater is discharged to drain), it has the advantage of reducing the energy requirement associated with regeneration of draw solution with a method such as reverse osmosis. Such a configuration would be useful for a coastal region where there is abundant water from other sources and the only need is to treat the wastewater and not recover process or potable quality water.

The concentration of dissolved N and P in the configuration in FIG. 5 may be higher compared to the configurations shown in FIGS. 2 and 3. This is because the FO membranes 4510 reject N and P, which accumulate in the system. This higher concentration of N and P goes to the struvite reactor through the MF/UF permeate 4501 and also through the WAS 4502 (after anaerobic digestion 4700 and a process such as belt thickening 4800). The high concentration of N and P in the struvite reactor influent 4909 may improve the yield and kinetics of the struvite reactor 4900. Moreover, since the majority of the struvite reactor influent 4909 comes in filtered through the MF/UF membranes, the final fertilizer product has much higher purity (low suspended impurities) compared to the configuration presented in FIGS. 2 and 3. Ferric chloride or alum may be added to the effluent 4901 from the struvite reactor 4900 to remove or reduce the concentration of dissolved P not removed by the struvite reactor 4900. Zeolite ion exchange systems may be used to remove ammonia from the struvite reactor effluent. The zeolite used in the ion-exchange systems may be clinoptiloite. In some embodiments ammonia in the struvite reactor effluent may be removed by converting to nitrogen gas using the Anammox process

### Example 6

FIG. 6 shows a configuration of the disclosed process/system 5000 which uses BNR system 1000 coupled with a hybrid MBR 5500 with osmotic (semipermeable) membranes 5510 as well as porous (MF or UF) membranes 5520. It does not have any chemical addition to remove P in the main treatment process.

Seawater is used as draw solution 5519 and the diluted seawater 5511 after FO 5510 is then desalinated with RO 5600 to operate the RO at lower energy and/or higher volumetric recovery. There can be variations of the above configuration where the process only incorporates either N or P removal but not necessarily both N and P removal (as shown above). The scheme of recirculation (shown above) between the various tanks is what could be typically used but other BNR recirculation schemes are also possible. The FO (forward osmosis) membranes 5520 reject suspended solids and a majority of the dissolved solids in the system and water is pulled across the FO membranes 5510 by the concentrated draw solution 5519 on the other side of the membranes. The draw solution 5519 gets diluted by the water coming across the FO membranes 5520 and is sent to the RO desalination system 5600. Since the seawater entering the RO system 5600 is diluted, the RO system can operate at lower energy and/or high volumetric recovery. The antiscalant addition to the RO process is also reduced because of the lower hardness associated with diluted seawater. The lower salinity and consequent lower pressure RO operation can allow the use of cheaper material of construction for pumps, piping, and process equipment instead of the expensive high grade stainless steel typically required for seawater desalination. For a given volumetric recovery, such a RO system that is fed by diluted seawater will produce permeate with significantly higher quality (lower total dissolved solids) compared to operation with undiluted seawater.

The concentration of dissolved N and P in the configuration in FIG. 6 may be higher compared to the configurations in FIGS. 2 and 3. This is because the FO membranes reject N and P, which accumulate in the system. This higher concentration of N and P goes to the struvite reactor 5900 through the MF/UF permeate 5501 and also through the WAS 5502 (after anaerobic digestion 5700 and a process such as belt thickening 5800). The high concentration of N and P in the struvite reactor influent 5909 may improve the yield and kinetics of the struvite reactor. Moreover, since the majority of the struvite reactor influent 5909 comes in filtered through the MF/UF membranes, the final fertilizer product has much higher purity (low suspended impurities) compared to the configuration presented in FIGS. 2 and 3. Ferric chloride or alum may be added to the effluent 5901 from the struvite reactor 5900 to remove or reduce the concentration of dissolved P not removed by the struvite reactor 5900. Zeolite ion exchange systems may be used to remove ammonia from the struvite reactor effluent 5901. The zeolite used in the ion-exchange systems may be clinoptiloite. In some embodiments ammonia in the struvite reactor effluent may be removed by converting to nitrogen gas using the Anammox process.

### Example 7

FIG. 7 shows a configuration of the disclosed process/system 6000 which does not have any steps for nitrification+denitrification (nitrogen removal) or anaerobic treatment (P removal), i.e. there is no BNR. It also does not have any chemical addition to remove P in the main treatment process.

A hybrid MBR 6500 with osmotic (semipermeable) membranes 6510 as well as porous (MF or UF) membranes 6520 is used. A recovery RO 6600 is used to concentrate the draw solution 6519. The FO (forward osmosis) membranes 6510 reject suspended solids and a majority of the dissolved solids in the system and water is pulled across the FO membranes 6510 by the concentrated draw solution 6519 on the other side of the membranes. The draw solution 6519 gets diluted by the water coming across the FO membranes and is sent to the RO system 6600 for concentration so it can again be returned to the FO membranes. The RO system 6600 produces permeate which is essentially filtered across two semipermeable membranes (FO and RO) and can potentially have very low dissolved solids (depending on the choice of draw solute(s) and rejection of the RO membranes) and thus can be used for process applications. Alternately, the RO permeate 6601 can be treated further as required by suitable methods such as UV followed by ozone to obtain potable quality water. Compared to the configuration in FIGS. 2 and 3 where the final treated water goes through a porous (MF or UF) followed by a semipermable (RO) membrane, the final treated water in the above configuration goes through two semipermeable membranes (FO and RO). Hence, the concentration of compounds such as endocrine disrupting chemicals (EDCs) may be lower in the RO permeate 6601 from the hybrid MBR shown above.

Since no BNR or chemical P removal is employed, there are significant savings for capital and operating costs related to BNR and chemical P removal. The organic nitrogen in the system is hydrolyzed so it is in the form of ammonia. It does not get oxidized to nitrate since the oxygen supply to the bioreactor is stoichiometrically limited for BOD removal only. Other methods for preventing or slowing down nitrification could be addition of nitrification inhibitor compounds, modifying physico-chemical parameters such as pH, temperature, salinity, etc. or operating the reactor as a high rate activate sludge process. There is no denitrification step. Also, there is no anaerobic step, which is required for bio-P removal.

The concentration of dissolved N and P in the configuration in FIG. 7 may be higher compared to the configurations in configuration in FIGS. 2 and 3. It is also significantly higher compared to inventive configurations in FIGS. 4, 5, and 6 because, unlike those configurations, the above configuration does not carry out nitrification+denitrification, anaerobic treatment or chemical P removal. So N is not lost as N2 gas and phosphorus is not absorbed significantly by sludge. Moreover, the FO membranes reject N and P (which accumulate in the system) and thus increase the concentration of N and P further. This higher concentration of N and P goes to the struvite reactor through the MF/UF permeate 6501 and also through the WAS 6502 (after anaerobic digestion 6700 and a process such as belt thickening 6800). The high concentration of N and P in the struvite reactor influent 6909 may improve the yield and kinetics of the struvite reactor. Moreover, since the majority of the struvite reactor influent 6909 comes in filtered through the MF/UF membranes, the final fertilizer product has much higher purity (low suspended impurities) compared to the configuration presented in FIGS. 2 and 3. Ferric chloride or alum may be added to the effluent 6901 from the struvite reactor 6900 to remove or reduce the concentration of dissolved P not removed by the struvite reactor. Zeolite ion exchange systems may be used to remove ammonia from the struvite reactor effluent. The zeolite used in the ion-exchange systems may be clinoptiloite. In some embodiments ammonia in the struvite reactor effluent may be removed by converting to nitrogen gas using the Anammox process.

### Example 8

FIG. 8 shows a configuration of the disclosed process/system 7000 which does not have any steps for nitrification+denitrification (nitrogen removal) or anaerobic treatment (P removal), i.e. there is no BNR. It also does not have any chemical addition to remove P in the main treatment process.

A hybrid MBR 7500 with osmotic (semipermeable) membranes 7510 as well as porous (MF or UF) membranes 7520 is used. In this configuration, seawater serves as the draw solution 7511 and gets diluted by the water coming across the FO membranes 7500. The diluted seawater 7511 is then discharged back to the ocean or marine body.

Even though treated water is not available in this configuration (since diluted seawater is discharged to drain), it has the advantage of significantly reducing the energy requirement associated with regeneration of draw solution with a method such as reverse osmosis. Such a configuration would be useful for a coastal region where there is abundant water from other sources and the only need is to treat the wastewater and not recover process or potable quality water.

Since no BNR or chemical P removal is employed, there are significant savings for capital and operating costs related to BNR and chemical P removal. The organic nitrogen in the system is hydrolyzed so it is in the form of ammonia. It does not get oxidized to nitrate since the oxygen supply to the bioreactor is stoichiometrically limited for BOD removal only. Other methods for preventing or slowing down nitrification could be addition of nitrification inhibitor compounds, modifying physico-chemical parameters such as pH, temperature, salinity, etc. or operating the reactor as a high rate activate sludge process. There is no denitrification step. Also, there is no anaerobic step, which is required for bio-P removal.

The concentration of dissolved N and P in the configuration in FIG. 8 may be higher compared to the configurations in configuration in FIGS. 2 and 3. It is also significantly higher compared to inventive configurations in FIGS. 4, 5, and 6 because, unlike those configurations, the above configuration does not carry out nitrification+denitrification, anaerobic treatment or chemical P removal. So N is not lost as N2 gas and phosphorus is not significantly absorbed by sludge. Moreover, the FO membranes reject N and P (which accumulate in the system) and thus increase the concentration on N and P further. This higher concentration of N and P goes to the struvite reactor 7900 through the MF/UF permeate 7501 and also through the WAS 7502 (after anaerobic digestion 7700 and a process such as belt thickening 7800). The high concentration of N and P in the struvite reactor influent 7909 may improve the yield and kinetics of the struvite reactor 7900. Moreover, since the majority of the struvite reactor influent 7909 comes in filtered through the MF/UF membranes, the final fertilizer product has much higher purity (low suspended impurities) compared to the configuration presented in FIGS. 2 and 3. Ferric chloride or alum may be added to the effluent 7901 from the struvite reactor 7900 to remove or reduce the concentration of dissolved P not removed by the struvite reactor. Zeolite ion exchange systems may be used to remove ammonia from the struvite reactor effluent. The zeolite used in the ion-exchange systems may be clinoptiloite. In some embodiments ammonia in the struvite reactor effluent may be removed by converting to nitrogen gas using the Anammox process.

### Example 9

FIG. 9 shows a configuration of the disclosed process/system 8000 which does not have any steps for nitrification+denitrification (nitrogen removal) or anaerobic treatment (P removal), i.e. there is no BNR. It also does not have any chemical addition to remove P in the main treatment process.

Seawater is used as draw solution 8519 and the diluted seawater 8511 after FO 8510 is then desalinated with RO 8600 to operate the RO at lower energy and/or higher volumetric recovery. The FO (forward osmosis) membranes 8600 reject suspended solids and a majority of the dissolved solids in the system and water is pulled across the FO membranes 8510 by the concentrated draw solution 8519 on the other side of the membranes. The draw solution 8519 gets diluted by the water coming across the FO membranes and is sent to the RO desalination system 8600. Since the seawater entering the RO system is diluted, the RO system can operate at lower energy and/or high volumetric recovery. The antiscalant addition to the RO process is also reduced because of the lower hardness associated with diluted seawater. The lower salinity and consequent lower pressure RO operation can allow the use of cheaper material of construction for pumps, piping and process equipment instead of the expensive high grade stainless steel typically required for seawater desalination. For a given volumetric recovery, such a RO system that is fed by diluted seawater will produce permeate with significantly higher quality (lower total dissolved solids) compared to operation with undiluted seawater.

Since no BNR or chemical P removal is employed, there are significant savings for capital and operating costs related to BNR and chemical P removal. The organic nitrogen in the system is hydrolyzed so it is in the form of ammonia. It does not get oxidized to nitrate since the oxygen supply to the bioreactor is stoichiometrically limited for BOD removal only. Other methods for preventing or slowing down nitrification could be addition of nitrification inhibitor compounds, modifying physico-chemical parameters such as pH, temperature, salinity, etc. or operating the reactor as a high rate activate sludge process. There is no denitrification step. Also, there is no anaerobic step, which is required for bio-P removal.

The concentration of dissolved N and P in the configuration in FIG. 9 may be higher compared to the configurations in FIGS. 2 and 3. It is also significantly higher compared to inventive configurations in FIGS. 4, 5, and 6 because, unlike those configurations, the above configuration does not carry out nitrification+denitrification, anaerobic treatment or chemical P removal. So N is not lost as N2 gas and phosphorus is not significantly absorbed by sludge. Moreover, the FO membranes reject N and P (which accumulate in the system) and thus increase the concentration on N and P further. This higher concentration of N and P goes to the struvite reactor 8900 through the MF/UF permeate 8501 and also through the WAS 8502 (after anaerobic digestion 8700 and a process such as belt thickening 8800). The high concentration of N and P in the struvite reactor influent 8909 may improve the yield and kinetics of the struvite reactor 8900. Moreover, since the majority of the struvite reactor influent 8909 comes in filtered through the MF/UF membranes, the final fertilizer product has much higher purity (low suspended impurities) compared to the configuration presented in FIGS. 2 and 3. Ferric chloride or alum may be added to the effluent 8901 from the struvite reactor 8900 to remove or reduce the concentration of dissolved P not removed by the struvite reactor. Zeolite ion exchange systems may be used to remove ammonia from the struvite reactor effluent 8901. The zeolite used in the ion-exchange systems may be clinoptiloite. In some embodiments ammonia in the struvite reactor effluent may be removed by converting to nitrogen gas using the Anammox process.

The inventions in FIGS. 7, 8, and 9 can radically change the current paradigm, which involves removing nitrogen as nitrogen gas and phosphorus by absorption in sludge or by chemical precipitation and incurs significant capital and operating costs as explained earlier. Instead of removing N (as N2 gas) and P (by absorption in sludge or by precipitation), the N and P are converted into dissolved species (ammonia and phosphate) and concentrated by the FO membranes, which reject the dissolved species. A majority of the dissolved N and P pass through the MF/UF membranes and the remainder N and P pass through the anaerobic digester followed by a process such as belt filtration and then the two streams with N and P enter the struvite reactor where they are recovered as high quality fertilizer by the struvite reactor. By drastically reducing the capital and operating costs associated with BNR and with chemical P removal and at the same time recovering N and P as fertilizer, the inventions in FIGS. 7 through 9 can dramatically reduce the carbon footprint of wastewater treatment processes and alleviate the impact on the environment due to the increasing quantity and deteriorating quality of wastewater associated with rapid urbanization.

The anaerobic digestion of WAS is an optional process and does not have to be necessarily carried out as part of the inventive processes presented in FIGS. 4 through 9.

The processes in FIGS. 4 through 9 can also be applied for waste treatment for industrial wastewaters or for wastewaters from animal farms or other sources which may have high content of N and P.

For the inventive processes presented in FIGS. 6 and 9, where seawater serves as the source of draw solution, which then gets diluted in the FO process, the salinity of seawater can drop so that it is in the range of 10000 to 30000 mg/L, preferably in the range of 15000 to 25000 mg/L. The actual concentration of the diluted seawater depends on the ratio of flow of water pulled across the FO membranes to the flow of incoming seawater draw solution. This diluted seawater with low salinity goes to the RO system which desalinates the diluted seawater.

Advantages of the processes in FIGS. 6 and 9 can be summarized as follows:

The FO process needs a draw solution with high salinity which is readily available in seawater

Compared to undiluted seawater, the diluted seawater with low salinity can provide the same recovery at significantly lower operating pressure (and energy cost) OR higher permeate recovery for a given operating pressure, OR a combination of energy reduction and increased permeate recovery

Compared to undiluted seawater, the diluted seawater also reduces the scaling tendency of seawater for a given volumetric recovery. This can reduce or eliminate costs associated with antiscalant dosage

The lower salinity and consequent lower pressure RO operation can allow the use of cheaper material of construction for pumps, piping, and process equipment instead of the expensive high grade stainless steel typically required for seawater desalination

FO membranes reject dissolved as well as suspended solids and hence provide nutrient (N and P) and BOD removal that is far superior to MF/UF membranes. This results in lower biofouling of downstream RO membranes when compared to treatment of permeate from MF/UF membranes in an MBR+RO or ASP+MF/UF+RO process. This can potentially reduce or even obviate the need to add chlorine and ammonia to form chloramines and control biofouling, thus reducing chemical costs and RO membrane degradation and eliminating the risk of accidental chlorine overdose that can damage RO membranes

FO membranes prevent passage of dissolved EPS, untreated BOD, and nutrients (N and P) in the event of a biological process upset and hence protect downstream RO membranes

The FO membranes followed by RO membranes offer two semi-permeable barriers for the wastewater. This provides far superior water quality compared to the MF/UF membrane followed by RO scheme used in MBR+RO and in ASP+MF/UF+RO which has only one semipermeable barrier

In some regions, there are environmental issues related to high salinity of SWRO reject stream sent back to the ocean affecting local marine flora and fauna. By using a diluted seawater feed, the concentration of RO reject can be lowered significantly to ease these environmental concerns

The disclosed process/system is a greener process that can reduce the carbon footprint of wastewater treatment and SWRO desalination.

It is to be understood that the above discussion provides a detailed description of various examples. The above descriptions will enable those skilled in the art to make many departures from the particular examples described above to provide apparatus constructed in accordance with the present process/system. The embodiments are illustrative, and not intended to limit the scope of the present process/system. Changes may be made in the construction and operation of the various components, elements and assemblies described herein and changes may be made in the steps or sequence of steps of the methods described herein. For example, although the present disclosure generally describes methods of purifying water, the disclosed methods and systems may be used to purify other liquids, such as a solvent in a mixed solvent system, to remove contaminants from a liquid, or to concentrate feed streams, such as liquid foods or chemical or biological solutions/suspensions in chemical or biological or pharmaceutical industries. The scope of the present process/system is rather to be determined by the scope of the claims as issued and equivalents thereto.

Unless otherwise explained, all technical and scientific terms used herein have the same meaning as commonly understood by one of ordinary skill in the art to which this disclosure belongs. In case of any such conflict, or a conflict between the present disclosure and any document referred to herein, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together. All numerical ranges given herein include all values, including end values (unless specifically excluded) and intermediate ranges.

Although methods and materials similar or equivalent to those described herein may be used in the practice or testing of the present disclosure, suitable methods and materials are described herein. The disclosed materials, methods, and examples are illustrative only and not intended to be limiting.

What is claimed is:

1. A treatment system having fluid contents, the treatment system comprising:
at least one tank containing the fluid contents of the treatment system;
the at least one tank operably associated with at least one first mechanism of forward osmosis that provides high removal of Total Dissolved Solids (TDS) and suspended solids and also operably associated with at least one second mechanism of microfiltration (MF) or ultrafiltration (UF) that provides low removal of TDS and high removal of suspended solids, each of the at least one first and the at least one second mechanism operating in parallel; and a discharge element to remove the suspended solids accumulating in at least one of the first mechanism and at least one of the second mechanism, wherein
the said first mechanism of forward osmosis produces a treated water stream with a concentration of TDS ranging from zero to significantly low and concentration of suspended solids ranging from zero to significantly low relative to the respective concentrations of TDS and suspended solids in the contents of the treatment system, and wherein
the said second mechanism of MF or UF produces a treated water stream with a concentration of TDS ranging from equal to or significantly similar to TDS concentration in the treatment system, and concentration of suspended solids ranging from zero to significantly lower relative to the respective concentrations of suspended solids in the contents of the treatment system.

2. The system of claim 1 wherein the at least one tank is an aerobic reactor that oxidizes organic carbon and hydrogen to remove only the carbonaceous oxygen demand (cBOD) while completely or significantly inhibiting nitrification, without a denitrification step through anoxic treatment and without phosphorus removal through anaerobic treatment or chemical addition to precipitate phosphorus.

3. The system of claim 1 wherein the at least one tank is an aerobic reactor that oxidizes organic carbon, hydrogen, and nitrogen (nitrification) without a denitrification step through anoxic treatment.

4. The system of claim 1 wherein the at least one tank is an aerobic reactor that oxidizes organic carbon, hydrogen, and nitrogen (nitrification) along with an anoxic reactor for denitrification.

5. The system of claim 1 wherein the at least one tank is an aerobic reactor that oxidizes organic carbon, hydrogen, and nitrogen (nitrification) along with an anoxic reactor for denitrification and an anaerobic reactor for phosphorus removal.

6. The system of claim 1 wherein the at least one tank is an aerobic reactor that oxidizes organic carbon, hydrogen, and nitrogen (nitrification) along with an anoxic reactor for denitrification, an anaerobic reactor for phosphorus removal and a chemical addition system to precipitate phosphorus.

7. The system of claim 1 wherein the at least one tank is an aerobic reactor that oxidizes organic carbon, hydrogen, and nitrogen (nitrification) along with an anoxic reactor for denitrification, and a chemical addition system to precipitate phosphorus.

8. The system of claim 1, wherein the at least one tank is an aerobic reactor that oxidizes organic carbon and hydrogen to remove only the carbonaceous oxygen demand (cBOD), while completely or significantly inhibiting nitrification, without a denitrification step through anoxic treatment and with an anaerobic reactor for phosphorus removal.

9. The system of claim 1, wherein the at least one tank is an aerobic reactor that oxidizes organic carbon and hydrogen to remove only the carbonaceous oxygen demand (cBOD), while completely or significantly inhibiting nitrification, without a denitrification step through anoxic treatment and with a chemical addition system for phosphorus removal.

10. The system of claim 1, wherein the at least one tank is an aerobic reactor that oxidizes organic carbon, hydrogen, and nitrogen (nitrification), without a denitrification step through anoxic treatment and with a chemical addition system to precipitate phosphorus.

11. The system of claim 1 wherein the treatment system is operated as an anaerobic bioreactor or anaerobic digester.

12. The system of claim 1, wherein an FO system is utilized, which uses a draw solution at an osmotic pressure higher than that of the contents of the treatment system and which gets diluted when mixed with the low TDS stream that is obtained after filtration of the contents of the treatment system by the FO membrane, with the diluted draw solution sent to a reconcentration system to increase the osmotic pressure of the draw solution so it may be sent back for further recovery of low TDS stream from the contents of the treatment system.

13. The system of claim 1, wherein an FO system is utilized, which uses a readily available stream as draw solution with osmotic pressure higher than that of the contents of the treatment system so that when the draw solution gets diluted, it is discharged and not recovered by a reconcentration system.

14. The system of claim 1, wherein an FO system uses a readily available stream as draw solution with osmotic pressure higher than that of the contents of the treatment system so that when the draw solution gets diluted, it becomes a more suitable feed water source for a treatment system to extract purified water with improved operating and energy efficiency compared to the case in which the draw solution would have been sent directly to the treatment system to extract purified water.

15. The system of claim 1, wherein a resource recovery system is installed to recover constituents of interest from the permeate from the second mechanism or from the discharge element that removes the suspended solids accumulating in the system or from both the permeate from the second mechanism and from the discharge element that removes the suspended solids accumulating in the system.

16. The resource recovery system in claim 15 can include a method such as addition of chemicals to the permeate stream from the second mechanism to precipitate nitrogen and phosphorus as a fertilizer such as magnesium ammonium phosphate (struvite).

17. The resource recovery system in claim 15 can include a method for anaerobic digestion of the waste suspended solids from the system to release nitrogen and phosphorus in the liquid phase, followed by separation of the solid phase by a solids separation method such as belt thickening followed by treatment of the nitrogen and phosphorus rich liquid stream by addition of chemicals to precipitate the nitrogen and phosphorus as a fertilizer such as magnesium ammonium phosphate (struvite).

18. The effluent from the resource recovery step in claim 15 can be discharged directly to waste or subjected to a polishing step such as adding chemicals to precipitate trace remaining constituents or using treatment methods such as ion exchange before discharging to waste.

19. The system of claim 1, wherein the second mechanism of microfiltration (MF) or ultrafiltration (UF) membrane system, which is located either within or outside the at least one tank, the second mechanism may be operated intermittently to accumulate specific constituents such as organic compounds, or nutrients, or other constituents of interest when the second mechanism is not operated, and extract and recover high concentration constituents when the second mechanism is operated.

20. The draw solution in claim 12 is at least one or more of the following: an organic compound, an inorganic salt, organic salt, magnetic nanoparticles, and particles with super hydrophilic moieties such as polyelectrolytes that may be filtered by pressure driven processes.

21. The draw solution reconcentration system in claim 12 may be reverse osmosis, nanofiltration, distillation, thermal decomposition of salt such as ammonium bicarbonate from their solutions into gases followed by resolubilization of the gases to form salt solutions, precipitation, membrane distillation, solvent polarity switching, magnetic separation, or other equivalent technology.

22. The readily available draw solution of claim 13 that is discharged after using it in the forward osmosis process to recover low TDS stream from the contents of the treatment system may be at least one of the following: seawater from open ocean, estuary or bay, concentrate from an RO system, concentrate from an NF system, or any water or wastewater which has osmotic pressure higher than that of contents of the treatment system.

23. The readily available draw solution of claim 14 that is diluted after it goes through the forward osmosis process and hence becomes a more suitable feed water source for a treatment system to extract purified water with improved operating and energy efficiency may be at least one of the following: seawater from open ocean, estuary or bay, reverse osmosis concentrate from an RO system, concentrate from an NF system, or any water or wastewater which has osmotic pressure higher than that of contents of the treatment system.

24. The treatment system of claim 14 is a concentration system such as a reverse osmosis, nanofiltration, distillation, electrodialysis, or membrane distillation system.

25. The system of claim 1 wherein the first mechanism may be located within or outside the tank containing the fluid contents of the treatment system.

26. The system of claim 1, wherein the second mechanism may be located within or outside the tanks containing the fluid contents of the treatment system.

27. The system of claim 1, wherein said first mechanism is located within or outside the at least one tank, and includes a cleaning mechanism to clean the membranes, the cleaning mechanism including a cross flow of the fluid contents across the membrane surface, a biphasic fluid flow consisting of a mixture of fluid contents and gas, or a combination of cross flow of the fluid contents across the membrane surface and a biphasic fluid flow consisting of a mixture of fluid contents and gas.

28. The system of claim 1, wherein said second mechanism is located within or outside the at least one tank, and includes a cleaning mechanism to clean the membranes, the cleaning mechanism including a cross flow of the fluid contents across the membrane surface, a biphasic fluid flow consisting of a mixture of fluid contents and gas, or a combination of cross flow of the fluid contents across the membrane surface and a biphasic fluid flow consisting of a mixture of fluid contents and gas.

29. The system of claim 1, wherein the biological process is operated as a sequencing batch reactor such that aerobic, anoxic, or anaerobic conditions can be achieved in a sequential and cyclical manner in the at least one tank by temporal variation of the supply of oxygen to the at least one tank, with the lowest possible supply of oxygen corresponding to the operation mode where the flow of oxygen is completely shut off.

30. The system as defined in claim 25, wherein the first mechanism when located within the tanks may be located in any one of the one or plurality of tanks that hold the contents of the treatment system.

31. The system as defined in claim 26, wherein the second mechanism when located within the tanks may be located in any one of the one or plurality of tanks that hold the contents of the treatment system.

32. The system of claim 25, wherein the first mechanism, when located outside a tank, draws liquid out of the one or plurality of tanks that hold the contents of the treatment system.

33. The system of claim 25, wherein the first mechanism when located outside the tank returns a portion or none of the liquid drawn from the one or plurality of tanks to the same or another of the at least one tank.

34. The system of claim 26, wherein when the second mechanism is located outside the tanks draws liquid out of the one or plurality of tanks that hold the contents of the treatment system.

35. The system of claim 26, wherein the second mechanism is located outside the tank returns a portion or none of the liquid drawn from the at least one tank to the same or another of the at least one tank.

36. The cleaning mechanism used to clean the forward osmosis membranes in claim 1 is osmotic backwashing wherein the draw solution in the draw solution channels is replaced with a solution with osmotic pressure lower than osmotic pressure of the solution on the feed side so that water diffuses through the forward osmosis membrane from the draw side to the feed side (bioreactor content side), thus removing fouling accumulated on the feed side of the forward osmosis membrane.

37. The system in claim 11, wherein when the system is operated as an anaerobic bioreactor or anaerobic digester and the cleaning mechanism used to clean the membranes employs a biphasic fluid flow consisting of a mixture of liquid and gas, the forward osmosis and microfiltration or ultrafiltration membranes are sealed from the atmosphere and the gas for the biphasic fluid flow could be drawn from the headspace of the tank.

38. The system of claim 11 wherein the system is operated as an anaerobic bioreactor or anaerobic digester and the headspace biogas is drawn and beneficially used for energy production.

39. The treatment system of claim 1, wherein liquids, solids, or gaseous substances are added to the at least one tank.

40. The treatment system of claim 1, wherein liquids, solids, or gaseous substances may be added to the at least one first mechanism.

41. The treatment system of claim 1, wherein liquids, solids, or gaseous substances may be added to the at least one second mechanism.

42. The treatment system of claim 1, wherein liquids, solids, or gaseous substances may be added to the discharge element that removes the suspended solids from the system.

43. A treatment system having fluid contents, the treatment system comprising:
at least one tank containing the fluid contents of the treatment system;
the at least one tank operably associated with at least one high Total Dissolved Solids (TDS) and high suspended solids removing first mechanism, and also operably associated with at least one low TDS and high suspended solids removing second mechanism, each of the at least one first and at the at least one second mechanism operating in parallel; and
a discharge element to eliminate the suspended solids accumulating in at least one of the first mechanism and at least one of the second mechanism,
wherein the at least one tank is an aerobic reactor that oxidizes organic carbon and hydrogen to remove only the carbonaceous oxygen demand (cBOD) while completely or significantly inhibiting nitrification, without a denitrification step through anoxic treatment and without phosphorus removal through anaerobic treatment or chemical addition to precipitate phosphorus, and
wherein the partial or complete prevention of oxidation of organic nitrogen and ammonia (nitrification) is achieved by one or more of the following methods:
a. Operating the system as a High Rate Activated Sludge Process
b. Partial or complete inhibition of the growth of nitrosomonas ammonia oxidizing bacteria (AOB) and/or nitrobacter nitrite oxidizing bacteria (NOB).

44. A treatment system having fluid contents, the treatment system comprising:
at least one tank containing the fluid contents of the treatment system;
the at least one tank operably associated with at least one high Total Dissolved Solids (TDS) and high suspended solids removing first mechanism, and also operably associated with at least one low TDS and high suspended solids removing second mechanism, each of the at least one first and at the at least one second mechanism operating in parallel; and
a discharge element to eliminate the suspended solids accumulating in at least one of the first mechanism and at least one of the second mechanism,
wherein the at least one tank is an aerobic reactor that oxidizes organic carbon and hydrogen to remove only the carbonaceous oxygen demand (cBOD), while completely or significantly inhibiting nitrification, without a denitrification step through anoxic treatment and with an anaerobic reactor for phosphorus removal, and
wherein the partial or complete prevention of oxidation of organic nitrogen and ammonia (nitrification) is achieved by one or more of the following methods:
a. Operating the system as a High Rate Activated Sludge Process
b. Partial or complete inhibition of the growth of nitrosomonas ammonia oxidizing bacteria (AOB) and/or nitrobacter nitrite oxidizing bacteria (NOB).

45. A treatment system having fluid contents, the treatment system comprising:
at least one tank containing the fluid contents of the treatment system;
the at least one tank operably associated with at least one high Total Dissolved Solids (TDS) and high suspended solids removing first mechanism, and also operably associated with at least one low TDS and high suspended solids removing second mechanism, each of the at least one first and at the at least one second mechanism operating in parallel; and
a discharge element to eliminate the suspended solids accumulating in at least one of the first mechanism and at least one of the second mechanism,
wherein the at least one tank is an aerobic reactor that oxidizes organic carbon and hydrogen to remove only the carbonaceous oxygen demand (cBOD), while completely or significantly inhibiting nitrification, without a denitrification step through anoxic treatment and with a chemical addition system for phosphorus removal, and
wherein the partial or complete prevention of oxidation of organic nitrogen and ammonia (nitrification) is achieved by one or more of the following methods:
a. Operating the system as a High Rate Activated Sludge Process
b. Partial or complete inhibition of the growth of nitrosomonas ammonia oxidizing bacteria (AOB) and/or nitrobacter nitrite oxidizing bacteria (NOB).

46. The treatment system of claim 2, 8, or 9, wherein the partial or complete prevention of oxidation of organic nitrogen and ammonia (nitrification) is achieved by one or more of the following methods:
a. Operating the system as a High Rate Activated Sludge Process
b. Partial or complete inhibition of the growth of nitrosomonas ammonia oxidizing bacteria (AOB) and/or nitrobacter nitrite oxidizing bacteria (NOB).

47. The treatment system of one of claims 43-46, wherein the High Rate Activated Sludge Process includes a solids retention time (SRT) and a hydraulic retention time (HRT) chosen to obtain high COD to microorganism ratio (F/M ratio or food to microorganism ratio) and minimal or no nitrification.

48. The treatment system of claim 47, wherein the solids retention time is between 12 hours to 8 days.

49. The treatment system of claim 48, wherein the solids retention time is between 3 to 5 days.

50. The treatment system of claim 47, wherein the hydraulic retention time is between 1 hour and 12 hours.

51. The treatment system of claim 50, wherein the hydraulic retention time is between 3 hours and 6 hours.

52. The treatment system of claim 47, wherein the chemical oxygen demand to microorganism ratio is between 0.4 kg and 2.5 kg of chemical oxygen demand per kg of mix liquor volatile suspended solids (kg COD/kg MLVSS), preferably in the range of 1 to 2 kg COD/kg MLVSS.

53. The treatment system of claim 52, wherein the chemical oxygen demand to microorganism ratio is between 1.0 kg and 2.0 kg of chemical oxygen demand per kg of mix liquor volatile suspended solids (kg COD/kg MLVSS).

54. The treatment system of one of claims 43-46, wherein inhibition of the growth of AOB and/or NOB is by either addition of one or more chemical inhibitor species, or modification of one or more physical or physico-chemical parameters.

55. The treatment system of claim 54, wherein the chemical inhibitor includes one or more organic compounds, inorganic compounds, or metals.

56. The treatment system of claim 55, wherein the chemical inhibitor is selected from the group consisting of 2-chloro-6-(trichloromethyl)-pyridine, 5-ethoxy-3-trichloromethyl-1,2,4-thiadiazol, Dicyandiamide, 2-amino-4-chloro-6-methyl-pyrimidine, 2-mercapto-benzothiazole, 2-sulfanilamidothiazole, Thiourea, 2,4-diamino-6-trichloromethyl-5-triazine, Polyetherionophores, 4-amino-1,2,4-triazole, 3-mercapto-1,2,4-triazole, Potassium azide, Carbon bisulfide, Sodium trithiocarbonate, Ammonium dithiocarbamate, 2,3, dihydro-2,2-dimethyl-7-benzofuranol, Methyl-carbamate, N-(2,6-dimethylphenyl)-N-(Methoxyacetyl), Alanine methyl ester, Ammonium thiosulfate, 1-hydroxypyrazole, 2-methylpyrazole-1-carboxamide, Acetone, Phenol, Carbon Disulfide, Ethylenediamine, Chloroform, Hexamethylene Diamine, Ethanol, Aniline, Monoethanolamine, Sodium Cyanide, Free Cyanide, Sodium Azide, Perchlorate, Hydrazine, Sodium Cyanate, Potassium Chromate, Chromium Cadmium, Silver Fluoride, Thiocyanate, Zinc, Copper, Mercury, Nickel, Arsenic (trivalent), Cobalt, and Lead.

57. The treatment system of claim 54, wherein the one or more physical or physico-chemical operating properties is selected from the group consisting of pH, temperature, dissolved oxygen, salinity, total dissolved solids, and alkalinity.

58. A treatment system having fluid contents, the treatment system comprising:
at least one tank containing fluid contents of the treatment system;
the at least one tank operably associated with a mechanism of microfiltration (MF) or ultrafiltration (UF) that provides low removal of TDS and high removal of suspended solid and a discharge element to remove the suspended solids accumulating in the treatment system
wherein the said mechanism of MF or UF produces a treated water stream with a concentration of TDS ranging from equal to or significantly similar to TDS concentration in the treatment system, and a concentration of suspended solids ranging from zero to significantly lower relative to the respective concentrations of suspended solids in the contents of the treatment system,
wherein a permeate from the MF or UF system is concentrated by reverse osmosis or nanofiltration prior to sending the permeate to the resource recovery system so as to increase the concentration of constituents of interest in the MF or UF permeate and increase the efficiency and yield of the resource recovery system and also to obtain clean water as reverse osmosis or nanofiltration permeate,
wherein the at least one tank is an aerobic reactor that oxidizes organic carbon and hydrogen to remove only the carbonaceous oxygen demand (cBOD) while completely or significantly inhibiting nitrification, without a denitrification step through anoxic treatment and without phosphorus removal through anaerobic treatment or chemical addition to precipitate phosphorus.

59. The system of claim 58, wherein a resource recovery system is installed to recover constituents of interest from the MF or UF permeate or from the discharge element that removes the suspended solids accumulating in the system or from both the MF or UF permeate and from the discharge element that removes the suspended solids accumulating in the system.

60. The resource recovery system in claim 59 can include a method such as addition of chemicals to the MF or UF permeate stream to precipitate nitrogen and phosphorus as a fertilizer such as magnesium ammonium phosphate (struvite).

61. The resource recovery system in claim 59 can include a method for anaerobic digestion of the waste suspended solids from the system to release nitrogen and phosphorus in the liquid phase, followed by separation of the solid phase by a solids separation method such as belt thickening followed by treatment of the nitrogen and phosphorus rich liquid stream by addition of chemicals to precipitate the nitrogen and phosphorus as a fertilizer such as magnesium ammonium phosphate (struvite).

62. The effluent from the resource recovery step in claim 59 can be discharged directly to waste or subjected to a polishing step such as adding chemicals to precipitate trace remaining constituents or using treatment methods such as ion exchange before discharging to waste.

63. The system of claim 58, wherein the microfiltration (MF) or ultrafiltration (UF) membrane system, which is located either within or outside the at least one tank, may be operated intermittently to accumulate specific constituents such as organic compounds, or nutrients, or other constituents of interest when the MF or UF is not operated, and extract and recover high concentration constituents when the MF or UF is operated.

64. The system of claim 58 wherein the MF or UF system may be located within or outside the tank containing the fluid contents of the treatment system.

65. The system of claim 58, wherein the MF or UF system is located within or outside the at least one tank, and includes a cleaning mechanism to clean the membranes, the cleaning mechanism including a cross flow of the fluid contents across the membrane surface, a biphasic fluid flow consisting of a mixture of fluid contents and gas, or a combination of cross flow of the fluid contents across the membrane surface and a biphasic fluid flow consisting of a mixture of fluid contents and gas.

66. The system as defined in claim 58, wherein the MF or UF system when located within the tanks may be located in any one of the one or plurality of tanks that hold the contents of the treatment system.

67. The system of claim 58, wherein the MF or UF system, when located outside a tank, draws liquid out of the one or plurality of tanks that hold the contents of the treatment system.

68. The system of claim 58, wherein the MF or UF system, when located outside the tank returns a portion or none of the liquid drawn from the one or plurality of tanks to the same or another of the at least one tank.

69. The treatment system of claim 58, wherein liquids, solids, or gaseous substances are added to the at least one tank.

70. The treatment system of claim 58, wherein liquids, solids, or gaseous substances may be added to the MF or UF system.

71. The treatment system of claim 58, wherein liquids, solids, or gaseous substances may be added to the discharge element that removes the suspended solids from the system.

72. The treatment system of claim 58, wherein the partial or complete prevention of oxidation of organic nitrogen and ammonia (nitrification) is achieved by one or more of the following methods:
a. Operating the system as a High Rate Activated Sludge Process
b. Partial or complete inhibition of the growth of nitrosomonas ammonia oxidizing bacteria (AOB) and/or nitrobacter nitrite oxidizing bacteria (NOB).

73. The treatment system of claim 72, wherein the High Rate Activated Sludge Process includes a solids retention time (SRT) and a hydraulic retention time (HRT) chosen to obtain high COD to microorganism ratio (F/M ratio or food to microorganism ratio) and minimal or no nitrification.

74. The treatment system of claim 73, wherein the solids retention time is between 12 hours to 8 days.

75. The treatment system of claim 74, wherein the solids retention time is between 3 to 5 days.

76. The treatment system of claim 73, wherein the hydraulic retention time is between 1 hour and 12 hours.

77. The treatment system of claim 76, wherein the hydraulic retention time is between 3 hours and 6 hours.

78. The treatment system of claim 73, wherein the chemical oxygen demand to microorganism ratio is between 0.4 kg and 2.5 kg of chemical oxygen demand per kg of mix liquor volatile suspended solids (kg COD/kg MLVSS), preferably in the range of 1 to 2 kg COD/kg MLVSS.

79. The treatment system of claim 78, wherein the chemical oxygen demand to microorganism ratio is between 1.0 kg and 2.0 kg of chemical oxygen demand per kg of mix liquor volatile suspended solids (kg COD/kg MLVSS).

80. The treatment system of claim 72, wherein inhibition of AOB and/or NOB is by either addition of one or more chemical inhibitor species, or modification of one or more physical or physico-chemical parameters.

81. The treatment system of claim 80, wherein the chemical inhibitor includes one or more organic compounds, inorganic compounds, or metals.

82. The treatment system of claim 81, wherein the chemical inhibitor is selected from the group consisting of 2-chloro-6-(trichloromethyl)-pyridine, 5-ethoxy-3-trichloromethyl-1,2,4-thiadiazol, Dicyandiamide, 2-amino-4-chloro-6-methyl-pyrimidine, 2-mercapto-benzothiazole, 2-sulfanilamidothiazole, Thiourea, 2,4-diamino-6-trichloromethyl-5-triazine, Polyetherionophores, 4-amino-1,2,4-triazole, 3-mercapto-1,2,4-triazole, Potassium azide, Carbon bisulfide, Sodium trithiocarbonate, Ammonium dithiocarbamate, 2,3, dihydro-2,2-dimethyl-7-benzofuranol, Methyl-carbamate, N-(2,6-dimethylphenyl)-N-(Methoxyacetyl), Alanine methyl ester, Ammonium thiosulfate, 1-hydroxypyrazole, 2-methylpyrazole-1-carboxamide, Acetone, Phenol, Carbon Disulfide, Ethylenediamine, Chloroform, Hexamethylene Diamine, Ethanol, Aniline, Monoethanolamine, Sodium Cyanide, Free Cyanide, Sodium Azide, Perchlorate, Hydrazine, Sodium Cyanate, Potassium Chromate, Chromium Cadmium, Silver Fluoride, Thiocyanate, Zinc, Copper, Mercury, Nickel, Arsenic (trivalent), Cobalt, and Lead.

83. The treatment system of claim 80, wherein the one or more physical or physio-chemical operating properties is selected from the group consisting of pH, temperature, dissolved oxygen, salinity, total dissolved solids, and alkalinity.

84. The treatment system in claim 54 or 80, wherein if the inhibiting chemical or chemicals are already present in the feedwater, it may not be necessary to add them to the system.
